(19) United States
(12) Patent Application Publication
(10) Pub. No.: US 2022/0302666 A1
(43) Pub. Date: Sep. 22, 2022

(54) BEAM QUALITY CONTROL DEVICE AND LASER DEVICE USING SAME

(71) Applicant: Fujikura Ltd., Tokyo (JP)

(72) Inventor: Yu Harumi, Chiba (JP)

(73) Assignee: Fujikura Ltd., Tokyo (JP)

(21) Appl. No.: 17/632,414

(22) PCT Filed: Dec. 15, 2020
(86) PCT No.: PCT/JP2020/046734

§ 371 Date: Feb. 2, 2022

(30) Foreign Application Priority Data
Dec. 17, 2019 (JP) 2019-227691
Dec. 17, 2019 (JP) 2019-227692

(51) Int. Cl. H01S 3/106; H01S 3/067; H01S 3/0941; H01S 3/094; H01S 3/10

(52) U.S. Cl. CPC H01S 3/1067; H01S 3/0675; H01S 3/09415; H01S 3/094053; H01S 3/10069

(57) ABSTRACT

A beam quality control device includes an optical fiber, a stress-applying portion, and a temperature controller. The optical fiber has a core and a cladding that surrounds an outer peripheral surface of the core. The stress-applying portion is in surface-contact with at least a portion of an outer peripheral surface of the optical fiber. The stress-applying portion has a coefficient of thermal expansion of the stress-applying portion that is different from a coefficient of thermal expansion of the cladding. The temperature controller controls a temperature of the stress-applying portion. The stress-applying portion contracts or expands due to the temperature being changed by the temperature controller such that a distribution of external force applied by the stress-applying portion to the cladding becomes non-uniform in a peripheral direction of the cladding.

### TECHNICAL FIELD

The present invention relates to a beam quality control device and a laser device using same.

### BACKGROUND

Laser devices are used in various fields such as the laser processing field and the medical field on account of having excellent light focusing properties, a high power density, and producing light for forming a small beam spot. As an example of a laser device, a laser processing machine used in the field of laser processing is described hereinbelow.

For example, when a laser processing machine cuts an object using a laser beam, which is emitted light, the laser processing machine preferably increases the power density of the laser beam, reduces the spot diameter of the laser beam, and irradiates the laser beam to a narrow area of the object, in order to increase the cutting accuracy.

In contrast, for example, when a laser processing machine welds an object by using a laser beam, the laser processing machine preferably reduces the density of the laser, increases the spot diameter of the laser beam, and projects the laser beam over a wide area of the object, in order to increase the uniformity of the welding.

In such laser processing, an example of one means of changing the diameter of the beam spot according to the intended use of the processing is to change the beam quality of the laser beam.

For example, Patent Literature 1 and Patent Literature 2 disclose laser devices that change the beam quality. In Patent Literature 1, a wedge-shaped glass member is inserted between and removed from between an upstream optical fiber that emits a laser beam and a downstream optical fiber that includes a plurality of optical waveguide layers. Furthermore, in Patent Literature 2, a lens that deflects a laser beam is disposed between an upstream optical fiber and a downstream optical fiber. In Patent Literature 1 and Patent Literature 2, the upstream optical fiber and the downstream optical fiber are optically coupled in space. The entry position of the laser beam incident on the downstream optical fiber may be changed by a glass member or a lens, and the mode, and the like, of the light propagating through the downstream optical fiber may change. That is, the beam quality of the laser beam propagating through the downstream optical fiber can change.
[Patent Literature 1] JP Patent Specification No. 6244308
[Patent Literature 2] PCT International Publication No. 2011/124671

### SUMMARY

In the laser devices disclosed in Patent Literature 1 and Patent Literature 2, the mode of the light is controlled in space. In this case, a slight change in the position or orientation of a glass member or a lens will cause a large change in the position in which the laser beam enters the downstream optical fiber. Such slight changes in the position and orientation of glass members and lenses can easily be caused by vibration, changes in environmental temperature, or the like. Therefore, vibrations, changes in environmental temperature, or the like, tend to cause unintentional large changes in the beam quality of light propagating through the downstream optical fiber. For this reason, it is difficult for the laser devices disclosed in Patent Literature 1 and Patent Literature 2 to produce light of the desired beam quality.

Therefore, one or more embodiments of the present invention relate to a beam quality control device capable of obtaining light of a desired beam quality, and a laser device using the same.

The beam quality control device of the present invention comprises: an optical fiber having a core and cladding that surrounds the outer peripheral surface of the core; a stress-applying portion that is in surface contact with at least a portion of the outer peripheral surface of the optical fiber and that has a coefficient of thermal expansion different from the coefficient of thermal expansion of the cladding; and a temperature-controlling portion (i.e., temperature controller) that controls the temperature of the stress-applying portion, wherein the stress-applying portion contracts or expands due to the temperature being changed by the temperature-controlling portion such that the distribution of an external force applied by the stress-applying portion to the cladding becomes non-uniform in the peripheral direction of the cladding.

In such a beam quality control device, the stress-applying portion contracts or expands when the temperature of the stress-applying portion is changed by the temperature-controlling portion. When the stress-applying portion contracts or expands, an external force applied by the stress-applying portion to the cladding changes non-uniformly in the peripheral direction of the cladding. If the external force changes non-uniformly, the distribution of stress applied to the core becomes non-uniform in the peripheral direction of the core, the distribution of the refractive index of the core changes, and the mode of light propagating through the core may change. Thus, in the beam quality control device, the stress applied to the core is controlled by temperature, whereby light of the desired beam quality is obtained. In addition, in the above beam quality control device, because the beam quality is controlled in the optical fiber, unintended changes in the beam quality can be suppressed in comparison with a case where the beam quality is controlled by arranging a glass member or a lens in space, even when vibrations or changes in environmental temperature, and so forth, occur as described above. Therefore, with the beam quality control device, light of the desired beam quality is obtained.

Furthermore, the beam quality control device may further comprise a plate-like, heat-conducting member (i.e., heat-conducting plate) which the stress-applying portion is disposed on a main surface of the heat-conducting member, which is thermally connected to the stress-applying portion and the temperature-controlling portion, and which conducts heat between the temperature-controlling portion and the stress-applying portion.

When the temperature-controlling portion generates heat, the heat of the temperature-controlling portion can easily be conducted across the entire heat-conducting member in the planar direction of the heat-conducting member, and can easily be conducted from the heat-conducting member to the stress-applying portion on the main surface of the heat-conducting member. Additionally, when the temperature-controlling portion absorbs heat, the heat of the stress-applying portion can be easily conducted across the entire heat-conducting member in the planar direction of the heat-conducting member, and can be easily conducted from the stress-applying portion to the heat-conducting member. Accordingly, the temperature of the stress-applying portion readily changes, and the magnitude of the stress on the stress-applying portion can easily change according to the temperature of the stress-applying portion. Therefore, with this beam quality control device, the magnitude of the stress in the stress-applying portion can be more easily changed than when the heat-conducting member is not in place.

Furthermore, the temperature-controlling portion may have a Peltier element that is thermally connected to the heat-conducting member.

In general, when current flows in a predetermined direction in the Peltier element, the temperature of one side of the Peltier element rises, and the temperature of the other side falls. In this case, when the heat-conducting member is disposed on one side, heat is transferred from one side to the stress-applying portion via the heat-conducting member, and the temperature of the stress-applying portion is raised by the Peltier element. Furthermore, when the current flows in the opposite direction to the foregoing direction, the temperature of one side falls and the temperature of the other side rises. In this case, when the heat-conducting member is disposed on one side, heat is transferred from the stress-applying portion to the Peltier element via the heat-conducting member, and the temperature of the stress-applying portion is lowered by the Peltier element. Thus, the temperature of the stress-applying portion changes according to the direction of the current flowing in the Peltier element, and the magnitude of the stress in the stress-applying portion can be controlled by the temperature of the stress-applying portion. Therefore, with this beam quality control device, the magnitude of the stress in the stress-applying portion can be controlled by the Peltier element.

Furthermore, the temperature-controlling portion may have a heat pump, and a flow passage through which a fluid whose temperature is changed by the heat pump flows, which penetrates the heat-conducting member, and which changes the temperature of the stress-applying portion using the fluid.

In this case, when the heat pump controls the temperature of the fluid, the temperature of the stress-applying portion is changed by the fluid via the heat-conducting member, and the magnitude of the stress in the stress-applying portion can be controlled by the temperature of the stress-applying portion. Therefore, with this beam quality control device, the magnitude of the stress in the stress-applying portion can be controlled by the fluid flowing through the flow passage.

Further, the stress-applying portion may be made of a resin with a non-uniform thickness between a contact surface that is in surface contact with the outer peripheral surface of the optical fiber and the outer peripheral surface of the stress-applying portion that is spaced apart from the contact surface.

In this case, variations in the temperature of the resin can cause inconsistency in the magnitude of the external force applied to the cladding, and the distribution of stress applied to the core can be non-uniform in the peripheral direction of the core.

Furthermore, when the temperature of the resin is lower than a predetermined temperature, the resin may contract so as to apply a tensile stress to the cladding, and when the temperature of the resin is higher than the predetermined temperature, the resin may expand so as to apply a compressive stress to the cladding.

In this case, the temperature-controlling portion can control the contraction or expansion of the resin by controlling the temperature of the resin, and can control the stress through contraction or expansion of the resin.

The beam quality control device further comprises a frame member that surrounds at least a portion of the stress-applying portion, wherein the coefficient of thermal expansion of the frame member may be smaller than the coefficient of thermal expansion of the stress-applying portion.

In this case, the stress-applying portion can press the cladding with a stronger external force toward the cladding than when the frame member is not in place, because upon expansion, the frame member suppresses the spread toward the frame member. Accordingly, the stress-applying portion is capable of applying a larger compressive stress to the cladding than when the frame member is not in place.

Further, the frame member may be made of metal.

In general, heat can be easily conducted via the frame member to the stress-applying portion because heat is readily conducted through metal. Therefore, with this beam quality control device, the stress in the stress-applying portion can change faster than when the frame member is not in place.

Furthermore, the stress-applying portion may have a plate member, and a pair of wall members that stand upright on the plate member and sandwich the optical fiber, wherein the plate member contracts or expands in the direction of alignment of the pair of wall members, and wherein the pair of wall members applies a compressive stress to the cladding through contraction of the plate member, and releases the application of the compressive stress through the expansion of the plate member.

In this case, the pair of wall members are capable of applying compressive stress, which is stress from both sides in the radial direction of the cladding, to the cladding through contraction, and of releasing the application of the compressive stress through expansion. As a result, the distribution of stress applied to the core becomes non-uniform in the peripheral direction of the core, and the mode of the light propagating through the core can change. Therefore, light of the desired beam quality can also be obtained by this beam quality control device.

Furthermore, the laser device of the present invention may comprise any of the beam quality control devices described above, and a light source that emits light, wherein the light propagates through the core of the optical fiber.

In this case, the laser device is capable of irradiating an object with light of a beam quality that is controlled by the beam quality control device. In addition, as described above, with this beam quality control device, light of the desired beam quality is obtained even when vibration or changes in environmental temperature, or the like, occur. Thus, light of the desired beam quality can irradiate the object.

Further, the laser device of the present invention may comprise any of the beam quality control devices described above and a pumping light source that emits pumping light, wherein the optical fiber propagates light amplified by an active element which is pumped by the pumping light.

For example, a resonator-type laser device or an MO-PA (Master Oscillator Power Amplifier)-type laser device, for example, may be cited as the laser device with the foregoing configuration. In this case, the laser device is capable of irradiating an object with light of a beam quality that is controlled by the beam quality control device. In addition, as described above, with this beam quality control device, light of the desired beam quality is obtained even when vibration or changes in environmental temperature, or the like, occur. Thus, light of the desired beam quality can irradiate the object.

In addition, the laser device may further comprise: an amplification optical fiber to which an active element is added; a first FBG that is provided on one side of the amplification optical fiber and that reflects light of at least some wavelengths of the light amplified by the active element; a second FBG that is provided on the other side of the amplification optical fiber and that reflects light of at least some wavelengths of the light reflected by the first FBG at a lower reflectance than the first FBG; and an emitting portion that emits light transmitted through the second FBG toward an object, wherein the beam quality control device may also be disposed between the emitting portion and the area of the second FBG which is farthest from the connection point between the amplification optical fiber and the optical fiber where the second FBG is provided.

This configuration makes it easier to bring the beam quality of the light emitted from the emitting portion closer to the desired beam quality than when the beam quality control device is disposed somewhere other than between the second FBG and the emitting portion.

Alternatively, the laser device may also further comprise a resonator that causes the light amplified by the active elements pumped by the pumping light to resonate, and the beam quality control device may be disposed inside the resonator.

In such a laser device, the beam quality control device is disposed inside the resonator, and the light travels back and forth inside the resonator. In this case, light propagates through the core each time the light travels back and forth inside the resonator, and each time same travels back and forth, the mode of the light can change in the optical fiber, and whereby light of the desired beam quality can be obtained. Furthermore, with the laser device of the present invention, the beam quality can be changed significantly in comparison with a case where the beam quality control device is disposed outside the resonator, and light of the desired beam quality can be obtained.

Furthermore, the resonator may comprise: an amplification optical fiber to which the active element is added; a first FBG that is provided on one side of the amplification optical fiber and that reflects light of at least some wavelengths of the light amplified by the active element; and a second FBG that is provided on the other side of the amplification optical fiber and that reflects light of at least some wavelengths of the light reflected by the first FBG at a lower reflectance than the first FBG, wherein the beam quality control device is disposed between the connection point between the amplification optical fiber and the optical fiber where the first FBG is provided, and the area of the first FBG which is farthest from the connection point.

The power density of light between the connection point and the area of the first FBG which is farthest from the connection point is lower than the power density of other areas between the first FBG and the second FBG. Therefore, when the beam quality control device is disposed between the connection point and this area, heat generation in the optical fiber of the beam quality control device can be suppressed in comparison with a case where the beam quality control device is disposed in the foregoing other area. Therefore, damage to the beam quality control device can be suppressed.

Alternatively, the resonator may comprise: an amplification optical fiber to which the active element is added; a first FBG that is provided on one side of the amplification optical fiber and that reflects light of at least some wavelengths of the light amplified by the active element; and a second FBG that is provided on the other side of the amplification optical fiber and that reflects light of at least some wavelengths of the light reflected by the first FBG at a lower reflectance than the first FBG, wherein the amplification optical fiber is the optical fiber in the beam quality control device.

Alternatively, the resonator may comprise an amplification optical fiber to which the active element is added; a first FBG that is provided on one side of the amplification optical fiber and that reflects light of at least some wavelengths of the light amplified by the active element; and a second FBG that is provided on the other side of the amplification optical fiber and that reflects light of at least some wavelengths of the light reflected by the first FBG at a lower reflectance than the first FBG, wherein the beam quality control device is disposed between the connection point between the amplification optical fiber and the optical fiber where the second FBG is provided, and the area of the second FBG which is farthest from the connection point.

The power density of light between the connection point and the area of the second FBG which is farthest from the connection point is higher than the power density of the light in other areas between the first FBG and the second FBG. Accordingly, when the beam quality control device is disposed between the connection point and this area, the beam quality may change more significantly than when the device is disposed in the foregoing other area, and it may be easier to make the beam quality of the light emitted from the emitting portion closer to the desired beam quality.

Alternatively, the first FBG may also be provided to the optical fiber in the beam quality control device.

Alternatively, the second FBG may also be provided in the optical fiber in the beam quality control device.

Further, the laser device may further comprise a storage portion that stores information on the beam quality of the light emitted from the laser device, wherein the temperature-controlling portion controls the temperature of the stress-applying portion to a temperature based on the information stored in the storage portion.

Due to the foregoing configuration, in the laser device, the temperature-controlling portion controls the temperature of the stress-applying portion on the basis of the information stored in the storage portion, and when the temperature of the stress-applying portion becomes the temperature based on this information, the beam quality of the light emitted from the laser device 1 can be the beam quality stored in the storage portion. As a result, the light of the beam quality stored in the storage portion can irradiate an object.

As described above, the present invention makes it possible to provide a beam quality control device with which light of a desired beam quality can be obtained, and to provide a laser device that uses the beam quality control device.

### BRIEF DESCRIPTION OF DRAWINGS

FIG. 1 is a diagram illustrating a laser device according to a first embodiment of the present invention.

FIG. 2 is a diagram illustrating the respective light sources of the laser device of FIG. 1.

FIG. 3 is a diagram illustrating a beam quality control device of the laser device of FIG. 1.

FIG. 4 is a diagram illustrating the application of stress from a stress-applying portion to cladding when the stress-applying portion of the beam quality control device contracts.

FIG. 5 is a diagram illustrating the application of stress from the stress-applying portion to the cladding when the stress-applying portion of the beam quality control device expands.

FIG. 6 is a diagram illustrating an example of the relationship between the temperature of the stress-applying portion according to the first embodiment and the amount of change in beam quality.

FIG. 7 is a diagram illustrating a beam quality control device according to a second embodiment.

FIG. 8 is a diagram illustrating a beam quality control device according to a third embodiment.

FIG. 9 is a diagram illustrating a light source of the laser device according to a fourth embodiment.

FIG. 10 is a diagram illustrating a beam quality control device of the light source of FIG. 9.

FIG. 11 is a diagram illustrating an example of the relationship between the temperature of the stress-applying portion according to the fourth embodiment, and the amount of change in beam quality.

FIG. 12 is a diagram illustrating a beam quality control device which is disposed in a light source, which is a modification example of the light source illustrated in FIG. 9, between the connection point between an amplification optical fiber and an optical fiber in which a first FBG is provided, and the area of the first FBG which is farthest from the connection point.

FIG. 13 is a diagram illustrating another modification example of the light source illustrated in FIG. 9, wherein the amplification optical fiber is an optical fiber of a beam quality control device.

FIG. 14 is a diagram illustrating a laser device according to a fifth embodiment.

FIG. 15 is a diagram illustrating a laser device according to a sixth embodiment.

FIG. 16 is a diagram illustrating a laser device according to a seventh embodiment.

### DETAILED DESCRIPTION

One or more embodiments of a laser device according to the present invention will be described in detail hereinbelow with reference to the drawings. The embodiments illustrated below are intended to facilitate understanding of the present invention and are not intended to be construed as limiting the present invention. The present invention can be modified and improved without deviating from the spirit thereof. Moreover, the present invention may also suitably combine constituent elements in each of the embodiments illustrated hereinbelow. Note that, for ease of understanding, some parts of each of the drawings may sometimes be indicated in an exaggerated manner.

### First Embodiment

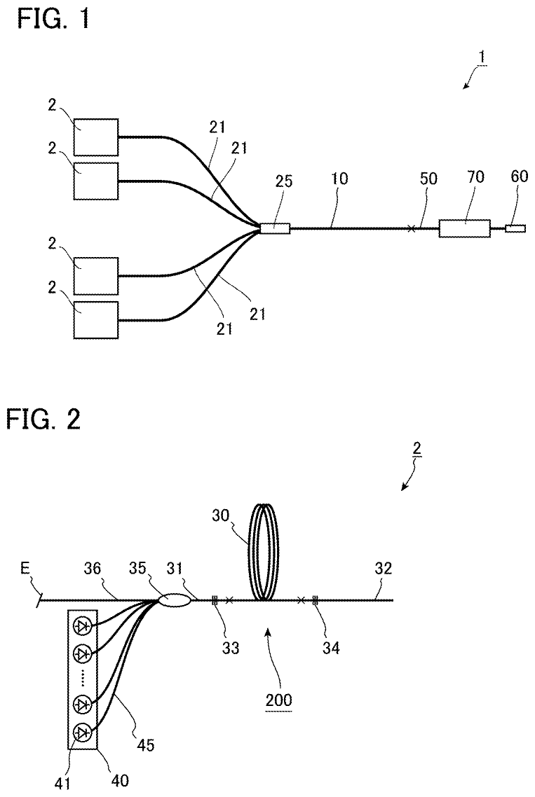

FIG. 1 is a diagram illustrating a laser device 1 according to the present invention. As illustrated in FIG. 1, the laser device 1 according to this embodiment comprises, in a main configuration, with: a plurality of light sources 2; an optical fiber 21 that propagates light emitted from each of the light sources 2; a delivery optical fiber 10 which light from the optical fiber 21 enters; a combiner 25; a beam quality control device 70 that comprises an optical fiber 50 which light from the delivery optical fiber 10 enters; and an emitting portion 60 provided at the end of the optical fiber 50.

FIG. 2 is a diagram illustrating respective light sources 2 in the laser device 1. As illustrated in FIG. 2, each light source 2 according to this embodiment comprise, in a main configuration, with: a pumping light source 40 that emits pumping light; and an amplification optical fiber 30 which the pumping light emitted from the pumping light source 40 enters and to which an active element that is pumped by the pumping light is added. In addition, each light source 2 further comprise, in a main configuration, with: an optical fiber 31 connected to one end of the amplification optical fiber 30; a first FBG (Fibber Bragg Gratings) 33 provided to the optical fiber 31; a combiner 35 for entering pumping light into the optical fiber 31; an optical fiber 32 connected to the other end of the amplification optical fiber 30; and a second FBG 34 provided to the optical fiber 32. In the case of the light source 2 according to this embodiment, a Fabry-Perot type resonator 200 is constituted by the amplification optical fiber 30, the first FBG 33, and the second FBG 34. Therefore, the light source 2 according to this embodiment is a resonator-type fiber laser device.

The pumping light source 40 includes a plurality of laser diodes 41. The pumping light source 40 emits pumping light of a wavelength that pumps the active element added to the amplification optical fiber 30. Each laser diode 41 of the pumping light source 40 is connected to a pumping optical fiber 45. The light emitted from the laser diodes 41 propagates through the pumping optical fiber 45 that is optically connected to the respective laser diodes 41. For example, a multimode fiber may be cited as an example of the pumping optical fiber 45, and in this case, the pumping light propagates through the pumping optical fiber 45 as multi-mode light. The wavelength of the pumping light is set to 915 nm, for example.

The amplification optical fiber 30 includes a core; an inner cladding that surrounds the outer peripheral surface of the core over the entire circumference thereof and gaplessly adheres to the outer peripheral surface of the core; an outer cladding that surrounds the outer peripheral surface of the inner cladding over the entire circumference thereof and is coated to adhere gaplessly to the outer peripheral surface of the inner cladding; and a coating layer that surrounds the outer peripheral surface of the outer cladding over the entire circumference thereof and gaplessly adheres to the outer peripheral surface of the inner cladding. The core of the amplification optical fiber 30 is made of quartz doped with ytterbium (Yb) as the active element, and, if necessary, an element such as germanium that increases the refractive index is added. Note that, although different from the configuration of the amplification optical fiber 30 according to this embodiment, rare earth elements other than ytterbium may be added as an active element to match the wavelength of the light to be amplified. Such rare earth elements include thulium (Tm), cerium (Ce), neodymium (Nd), europium (Eu), and erbium (Er). In addition to rare earth elements, bismuth (Bi) and other elements can be used as active elements. Furthermore, the material that constitutes the inner cladding of the amplification optical fiber 30 is, for example, pure quartz without any dopant added. Note that elements that reduce the refractive index, such as fluorine (F) and boron (B), for example, may be added to the inner cladding. Further, examples of the material constituting the outer cladding of the amplification optical fiber 30 include a resin with a lower refractive index than the inner cladding. Further, examples of the material constituting the coating layer of the amplification optical fiber 30 include a resin that is different from the resin constituting the outer cladding. The amplification optical fiber 30 is a single-mode fiber, but may be configured to propagate single-mode light while the core diameter is similar to that of a multi-mode fiber such that signal light with high power can propagate through the core of the amplification optical fiber 30. The amplification optical fiber 30 may also be a multi-mode fiber.

The optical fiber 31 has the same configuration as the amplification optical fiber 30, except that no active element is added to the core. The optical fiber 31 is connected to one end of the amplification optical fiber 30. Therefore, the core of the amplification optical fiber 30 is optically coupled to the core of the optical fiber 31, and the inner cladding of the amplification optical fiber 30 is optically coupled to the inner cladding of the optical fiber 31.

The first FBG 33 is provided to the core of the optical fiber 31 that is connected to one side of the amplification optical fiber 30. The first FBG 33 is constituted by repeated portions with a higher refractive index at a certain period along the longitudinal direction of the optical fiber 31. By adjusting this period, the first FBG 33 reflects the light of a predetermined wavelength band of the light emitted by the active element, which is in a pumped state, of the amplification optical fiber 30.

Furthermore, in the combiner 35, the core of the pumping optical fiber 45 is connected to the inner cladding of the optical fiber 31. Thus, the pumping optical fiber 45, which is connected to the pumping light source 40, and the inner cladding of the amplification optical fiber 30 are optically coupled via the inner cladding of the optical fiber 31.

Furthermore, in the combiner 35, an optical fiber 36 is connected to the optical fiber 31. The optical fiber 36 is, for example, an optical fiber having a core with the same diameter as the core of the optical fiber 31. One end of the optical fiber 36 is connected to the optical fiber 31, and the core of the optical fiber 36 is optically coupled to the core of the optical fiber 31. Further, a heat-converting portion E is connected to the opposite side of the optical fiber 36 from that of the combiner 35.

The optical fiber 32 includes: a core similar to the core of the amplification optical fiber 30 except that no active element is added; a cladding similar in configuration to the inner cladding of the amplification optical fiber 30; and a coating layer similar in configuration to the coating layer of the amplification optical fiber 30. The cladding of the optical fiber 32 surrounds the outer peripheral surface of the core of the optical fiber 32 over the entire circumference thereof and gaplessly adheres to the outer peripheral surface of the core. The coating layer of the optical fiber 32 surrounds the outer peripheral surface of the cladding of the optical fiber 32 over the entire circumference thereof and gaplessly adheres to the outer peripheral surface of the cladding. The optical fiber 32 is connected to the other end of the amplification optical fiber 30, and the core of the amplification optical fiber 30 is optically coupled to the core of the optical fiber 32.

The second FBG 34 is provided to the core of the optical fiber 32 that is connected to the other side of the amplification optical fiber 30. The second FBG 34 is constituted by repeated portions with a higher refractive index at a certain period along the longitudinal direction of the optical fiber 32. Due to this configuration, the second FBG 34 reflects light of at least some wavelengths of the light reflected by the first FBG 33 at a lower reflectance than the first FBG 33.

Further, the optical fiber 21 illustrated in FIG. 1 is connected to the opposite side of the optical fiber 32 from that of the amplification optical fiber 30, and the optical fiber 32 and the optical fiber 21 constitute one optical fiber. Note that by extending the optical fiber 32, a portion of the optical fiber 32 may be used as the optical fiber 21.

The core of each optical fiber 21 is optically coupled to the core of the delivery optical fiber 10 by a combiner 25. The delivery optical fiber 10 is, for example, a multi-mode fiber in which multi-mode light propagates. The combiner 25 is, for example, a bridge fiber that has been processed in a tapered shape. In this case, the core of the respective optical fiber 21 is connected to the end face on the large diameter side of the bridge fiber, which is the combiner 25, and the core of the delivery optical fiber 10 is connected to the end face on the small diameter side of the bridge fiber, which is the combiner 25. Thus, the core of the respective optical fiber 21 and the core of the delivery optical fiber 10 are optically coupled via the combiner 25. Note that the combiner 25 is not limited to the bridge fiber described above, as long as same optically couples the core of the respective optical fiber 21 to the core of the delivery optical fiber 10, rather, the core of the respective optical fiber 21 may also be directly connected to the core of the delivery optical fiber 10, for example.

The optical fiber 50 of the beam quality control device 70 is connected to the opposite side of the delivery optical fiber 10 to the combiner 25 side, and the delivery optical fiber 10 and the optical fiber 50 form one optical fiber. Note that, by extending the delivery optical fiber 10, a portion of the delivery optical fiber 10 may be used as the optical fiber 50. The configuration of the delivery optical fiber 10 is the same as the configuration of the optical fiber 50 described below. The light amplified by the active element pumped by the pumping light propagates from the first FBG 33 through the optical fiber 31 in the emitting portion 60, the amplification optical fiber 30, the optical fibers 32, 21, the delivery optical fiber 10, and then the optical fiber 50.

The emitting portion 60 emits the light propagated from the optical fiber 50 to an object or the like. The emitting portion 60 is, for example, a glass rod with a diameter larger than the diameter of the core 51 (described subsequently) of the optical fiber 50. Note that the emitting portion 60 may be an end of the optical fiber 50, or may be an optical component such as a lens attached to the end of the optical fiber 50.

Incidentally, as described above, the resonator 200 is constituted by an amplification optical fiber 30, a first FBG 33, and a second FBG 34. Accordingly, the beam quality control device 70 according to this embodiment, which comprises the optical fiber 50, is disposed outside the resonator 200. An example is illustrated in which the beam quality control device 70 according to this embodiment is disposed between the connection point between the delivery optical fiber 10 and the optical fiber 50 and the emitting portion 60.

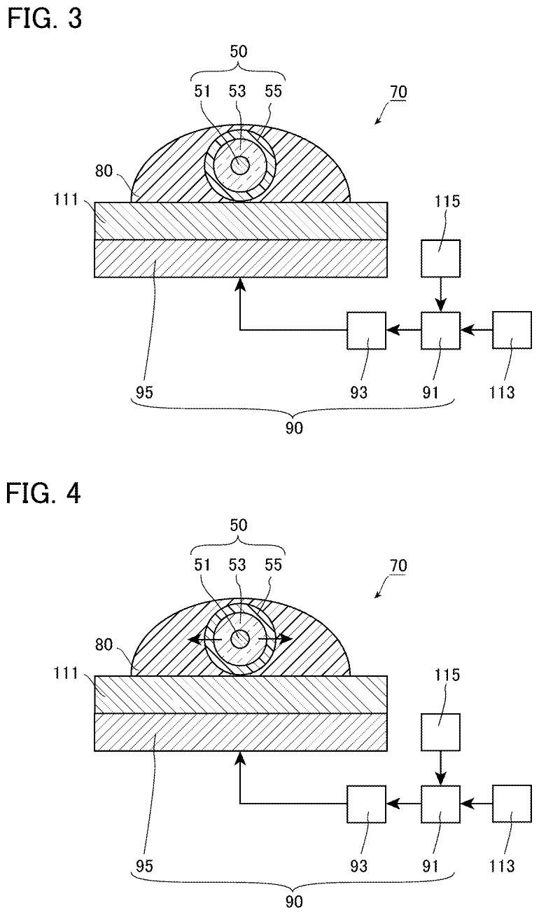

Next, the configuration of the beam quality control device 70 will be described using FIG. 3. FIG. 3 is a diagram illustrating a beam quality control device 70.

The optical fiber 50 of the beam quality control device 70 includes: a core 51 through which light propagates; cladding 53 that surrounds the outer peripheral surface of the core 51 over the entire circumference thereof and gaplessly adheres to the outer peripheral surface of the core 51; and a coating layer 55 that surrounds the outer peripheral surface of the cladding 53 over the entire circumference thereof and gaplessly adheres to the outer peripheral surface of the cladding 53. For example, glass is used for the core 51 and the cladding 53, and resin is used for the coating layer 55. For example, the core 51 has the same configuration as the core of the amplification optical fiber 30 except that no active element is added. For example, the cladding 53 has the same configuration as the inner cladding of the amplification optical fiber 30. For example, the coating layer 55 has the same configuration as the coating layer of the amplification optical fiber 30.

The beam quality control device 70 also includes a stress-applying portion 80, a temperature-controlling portion 90, a heat-conducting member 111, an input portion 113, and a storage portion 115.

The stress-applying portion 80 according to this embodiment is made of a moisture-curing resin, for example. This resin is, for example, a silicone resin. Further, the heat-conducting member 111 consists of a metal plate member, such as copper or aluminum nitride, for example.

The stress-applying portion 80 surrounds the outer peripheral surface of the coating layer 55 over the entire circumference thereof and gaplessly adheres to the outer peripheral surface of the coating layer 55, and is in surface contact with the outer peripheral surface. Therefore, the outer peripheral surface of the optical fiber 50 is buried in the stress-applying portion 80. Note that the stress-applying portion 80 should be in surface contact with at least a portion of the outer peripheral surface of the optical fiber 50. The thickness of the stress-applying portion 80 is non-uniform between the contact surface of the stress-applying portion 80 that is in surface contact with the outer peripheral surface of the coating layer 55 and the outer peripheral surface of the stress-applying portion 80 that is spaced apart from that contact surface. Accordingly, the distance between the outer peripheral surface of the cladding 53 in the radial direction of the optical fiber 50 and the outer peripheral surface of the stress-applying portion 80 is not constant and is non-uniform. For example, the stress-applying portion 80 has a semi-elliptical shape and is longer in the planar direction of the heat-conducting member 111 than in the thickness direction of the heat-conducting member 111. The length of the stress-applying portion 80 in the planar direction of the heat-conducting member 111 is sufficiently longer than the diameter of the optical fiber 50, and the length of the stress-applying portion 80 in the thickness direction of the heat-conducting member 111 is minutely longer than the diameter of the optical fiber 50. The stress-applying portion 80 is disposed on the main surface of the heat-conducting member 111 together with the optical fiber 50, and fixes the optical fiber 50 to the heat-conducting member 111. For example, the stress-applying portion 80 surrounds the optical fiber 50 in a section of the total length of the optical fiber 50.

The temperature-controlling portion 90 includes a temperature control main body portion 91, a power supply 93, and a Peltier element 95.

For example, an integrated circuit such as a microcontroller, an IC (Integrated Circuit), an LSI (Large-scale Integrated Circuit), an ASIC (Application Specific Integrated Circuit), or an NC (Numerical Control) device can be used as the temperature control main body portion 91. When an NC device is used, the temperature-controlling portion 90 may also be a temperature-controlling portion that uses a machine learner, or may be one that does not use a machine learner.

The intended use of the laser device 1, which incorporates the beam quality control device 70, is inputted to the temperature control main body portion 91 from the input portion 113. In this case, the temperature control main body portion 91 accesses the storage portion 115 and reads the temperature of the stress-applying portion 80 corresponding to the intended use of the laser device 1 from a table stored in the storage portion 115.

The voltage of the power supply 93 is controlled by the temperature control main body portion 91 such that the temperature of the stress-applying portion 80 becomes the temperature read from the table. The power supply 93 applies the voltage to the Peltier element 95.

When current flows through the Peltier element 95 in a predetermined direction due to the application of the voltage, the temperature of one side of the Peltier element 95, which will be described subsequently, rises, and the temperature of the other side falls. Further, when the voltage is switched and the current flows in the opposite direction to the foregoing, the temperature of one side of the Peltier element 95 falls and the temperature of the other side rises. The temperatures of one side and the other side of the Peltier element 95 vary according to the magnitude of the current flowing in the Peltier element 95. By changing the magnitude of the current, the degree of change in the temperature of the Peltier element 95 changes. If the magnitude of the current is constant, the temperature of the Peltier element 95 will be constant. When no current flows, the Peltier element 95 does not generate heat or absorb heat.

The heat-conducting member 111 is disposed on one side of the Peltier element 95. As mentioned above, when current flows through the Peltier element 95 in a predetermined direction, the temperature of one side of the Peltier element 95 rises. In this case, the heat of the Peltier element 95 is transferred to the stress-applying portion 80 via the heat-conducting member 111, and the temperature of the stress-applying portion 80 is raised by the Peltier element 95. In addition, as described above, when current flows in a direction opposite to the foregoing direction, the temperature of one side of the Peltier element 95 on which the heat-conducting member 111 is disposed falls. In this case, heat of the stress-applying portion 80 is transferred from the stress-applying portion 80 to the Peltier element 95 via the heat-conducting member 111, and the temperature of the stress-applying portion 80 is lowered by the Peltier element.

The stress-applying portion 80 is disposed on one side of the main surface of the heat-conducting member 111, and the other side of the main surface of the heat-conducting member 111 is placed on the Peltier element 95. The heat-conducting member 111 is thermally connected to the stress-applying portion 80 and the Peltier element 95, and conducts heat between the Peltier element 95 and the stress-applying portion 80. When the temperature of one side of the Peltier element 95 rises and the temperature of the other side falls, the heat-conducting member 111 conducts the heat generated from the Peltier element 95 to the stress-applying portion 80. When the temperature of one side of the Peltier element 95 falls and the temperature of the other side rises, the heat-conducting member 111 conducts the heat of the stress-applying portion 80 to the Peltier element 95.

The coefficient of thermal expansion of the heat-conducting member 111 is larger than the coefficient of thermal expansion of the cladding 53 and the coefficient of thermal expansion of the stress-applying portion 80, and smaller than the coefficient of thermal expansion of the coating layer 55.

The input portion 113 is operated by the operator who operates the laser device 1. The input portion 113 inputs the intended use of the laser device 1, namely, shaving off or welding, for example, to the temperature control main body portion 91. The input portion 113 is a general input device such as, for example, a keyboard, mouse or other pointing device, a button switch, a dial, or the like. The input portion 113 may select and input one certain use from among a plurality of intended uses displayed on the display unit while the operator is visually looking at the display unit such as a monitor which is not illustrated. The input portion 113 may be used by the operator to input various commands to operate the laser device 1.

The storage portion 115 stores a table that illustrates the relationship between the intended use of the laser device 1 and the temperature of the stress-applying portion 80 corresponding to the intended use. The storage portion 115 is, for example, a memory.

Next, the application of stress to the optical fiber 50 by the stress-applying portion 80 will be described.

The coefficient of thermal expansion of the stress-applying portion 80 is different from the coefficient of thermal expansion of the cladding 53. It is assumed in the description hereinbelow that the coefficient of thermal expansion of the stress-applying portion 80 is greater than the coefficient of thermal expansion of the cladding 53. Furthermore, the coefficient of thermal expansion of the stress-applying portion 80 and the coefficient of thermal expansion of the cladding 53 are smaller than the coefficient of thermal expansion of the coating layer 55.

When the temperature of the stress-applying portion 80 is at a certain predetermined temperature, the stress-applying portion 80 is not contracting or expanding, and is in a state where no stress, such as tensile stress or compressive stress, is being applied to the cladding 53 via the coating layer 55. Furthermore, similar to the stress-applying portion 80, the coating layer 55 is not contracting or expanding at a certain predetermined temperature, and is in a state where no stress, such as tensile stress or compressive stress, is being applied to the cladding 53. In this case, the distribution of the external force applied to the cladding 53 by the stress-applying portion 80 and the coating layer 55 is uniform in the peripheral direction of the cladding 53. The predetermined temperature is, for example, the temperature when the moisture-curing resin that is the stress-applying portion 80 is cured.

For example, when the temperature of one side of the Peltier element 95 falls and the temperature of the other side of the Peltier element 95 rises, the heat of the stress-applying portion 80 is conducted to the Peltier element 95 via the heat-conducting member 111. Accordingly, the temperature of the stress-applying portion 80 falls below the predetermined temperature, and the stress-applying portion 80 contracts in comparison with when same is at the predetermined temperature. At such time, the outer peripheral surface of the stress-applying portion 80 and the inner peripheral surface of the stress-applying portion 80 approach each other such that the thickness of the stress-applying portion 80 becomes thinner. Furthermore, the heat of the coating layer 55 is conducted to the Peltier element 95 via the stress-applying portion 80 and the heat-conducting member 111, and the temperature of the coating layer 55 falls below the predetermined temperature. Therefore, the coating layer 55 also contracts in comparison with when same is at the predetermined temperature, similarly to the stress-applying portion 80.

Because the coefficient of thermal expansion of the stress-applying portion 80 is greater than the coefficient of thermal expansion of the cladding 53 as described above, the stress-applying portion 80 contracts to a greater extent than the cladding 53. Further, as illustrated in FIG. 4, the stress-applying portion 80 can then pull the cladding 53 via the coating layer 55 at the inner peripheral surface of the stress-applying portion 80 and can apply a tensile stress to the cladding 53.

Because the coefficient of thermal expansion of the coating layer 55 is greater than the coefficient of thermal expansion of the stress-applying portion 80 and the coefficient of thermal expansion of the cladding 53 as described above, the coating layer 55 contracts to a greater extent than the stress-applying portion 80 and the cladding 53. In this case, the outer peripheral surface of the coating layer 55 is suppressed by the contraction toward the cladding 53 due to the contraction at the inner peripheral surface of the stress-applying portion 80. Therefore, the coating layer 55 can pull the cladding 53 with a stronger force than when the stress-applying portion 80 is not in place. Accordingly, the coating layer 55 can apply a greater tensile stress to the cladding 53 than when the stress-applying portion 80 is not in place.

Furthermore, for example, when the temperature of one side of the Peltier element 95 rises and the temperature of the other side of the Peltier element 95 falls, the heat of the Peltier element 95 is conducted to the stress-applying portion 80 via the heat-conducting member 111. Accordingly, the temperature of the stress-applying portion 80 rises above the predetermined temperature, and the stress-applying portion 80 expands compared to when same is at the predetermined temperature. At such time, the outer peripheral surface of the stress-applying portion 80 and the inner peripheral surface of the stress-applying portion 80 move away from each other such that the thickness of the stress-applying portion 80 increases. Furthermore, the heat of the Peltier element 95 is also conducted to the coating layer 55 via the heat-conducting member 111 and the stress-applying portion 80, and the temperature of the coating layer 55 rises above the predetermined temperature. Therefore, the coating layer 55 also expands in comparison with when same is at the predetermined temperature, similarly to the stress-applying portion 80.

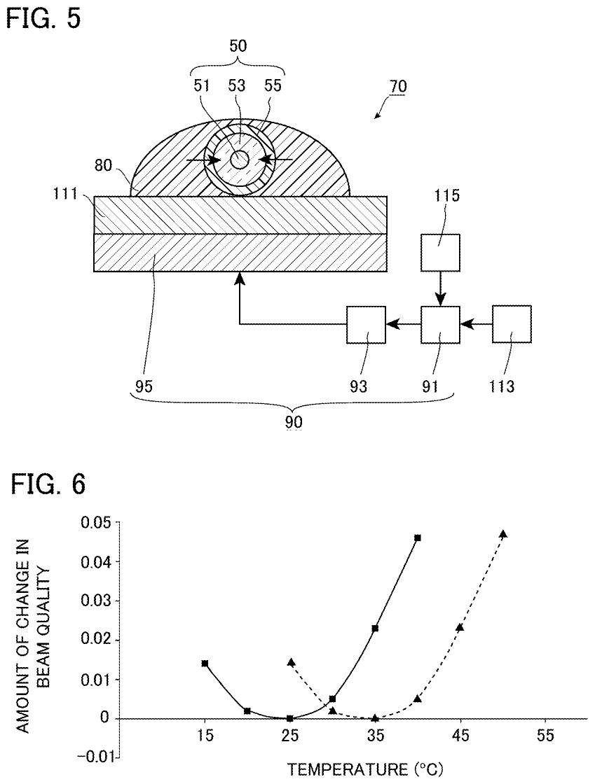

Because the coefficient of thermal expansion of the stress-applying portion 80 is greater than the coefficient of thermal expansion of the cladding 53 as described above, the stress-applying portion 80 expands to a greater extent than the cladding 53. As illustrated in FIG. 5, the stress-applying portion 80 can then press the cladding 53 via the coating layer 55 at the inner peripheral surface of the stress-applying portion 80 and can apply a compressive stress to the cladding 53.

Furthermore, because the coefficient of thermal expansion of the coating layer 55 is greater than the coefficient of thermal expansion of the stress-applying portion 80 and the coefficient of thermal expansion of the cladding 53 as described above, the coating layer 55 expands to a greater extent than the stress-applying portion 80 and the cladding 53. In this case, the expansion of the outer peripheral surface of the coating layer 55 toward the stress-applying portion 80 is suppressed by the expansion at the inner peripheral surface of the stress-applying portion 80. Therefore, the coating layer 55 can press the cladding 53 with a stronger force than when the stress-applying portion 80 is not in place. Accordingly, the coating layer 55 can apply a greater compressive stress to the cladding 53 than when the stress-applying portion 80 is not in place.

Thus, the stress-applying portion 80 can contract or expand according to the temperature of the stress-applying portion 80, and can apply stress, namely a tensile stress, to the cladding 53, through contraction, and can apply stress, namely a compressive stress, to the cladding 53, through expansion. The coating layer 55 can also contract or expand according to the temperature of the coating layer 55, and can apply stress, namely a tensile stress, to the cladding 53, through contraction, and can apply stress, namely a compressive stress, to the cladding 53, through expansion.

The degree of contraction of the stress-applying portion 80 increases as the temperature of the stress-applying portion 80 becomes lower than the predetermined temperature. Therefore, the magnitude of the tensile stress in the stress-applying portion 80 increases as the temperature of the stress-applying portion 80 becomes lower than the predetermined temperature. In addition, the degree of expansion of the stress-applying portion 80 increases as the temperature of the stress-applying portion 80 becomes higher than the predetermined temperature. Therefore, the magnitude of the compressive stress in the stress-applying portion 80 increases as the temperature of the stress-applying portion 80 becomes higher than the predetermined temperature. Similarly, the magnitude of the tensile stress in the coating layer 55 increases as the temperature of the coating layer 55 becomes lower than the predetermined temperature. In addition, the magnitude of the compressive stress in the coating layer 55 increases as the temperature of the coating layer 55 becomes higher than the predetermined temperature.

As the magnitude of stresses such as compressive stress and tensile stress changes as described above, the external force applied to the cladding 53 by the stress-applying portion 80 and the coating layer 55 changes, and the distribution of the external force in the cladding 53 becomes non-uniform in the peripheral direction of the cladding 53. Accordingly, the distribution of stress applied to the core 51 is non-uniform in the peripheral direction of the core 51, and the distribution of the refractive index of the core 51 may change and the mode of light propagating through the core 51 may change. Thus, when the stress applied to the core 51 is controlled by temperature, this control controls the beam quality in the optical fiber 50, whereby light of the desired beam quality is obtained.

Next, using FIG. 6, an example of the relationship between the temperature of the stress-applying portion 80 according to this embodiment, which is controlled by the temperature-controlling portion 90, and the amount of change in beam quality, will be described. FIG. 6 is a diagram illustrating an example of the relationship between the temperature of the stress-applying portion 80 according to this embodiment and the amount of change in beam quality.

Here, the graph indicated by the solid line in FIG. 6 will now be described. In this graph, the foregoing predetermined temperature is set to 25° C., for example. Therefore, in this case, the distribution of the external force is uniform in the peripheral direction of the cladding 53, and the amount of change in beam quality is zero. The temperature of the stress-applying portion 80 and the amount of change in beam quality in this case are described below.

When the temperature of the stress-applying portion 80 is 20° C., the tensile stress in the stress-applying portion 80 results in an amount of change in beam quality of 0.003, and when the temperature of the stress-applying portion 80 is 15° C., the larger tensile stress applied by the stress-applying portion 80 results in an amount of change in beam quality of 0.015. Furthermore, when the temperature of the stress-applying portion 80 is 30° C., the compressive stress of the stress-applying portion 80 results in an amount of change in beam quality of 0.007, when the temperature of the stress-applying portion 80 is 35° C., the larger compressive stress applied by the stress-applying portion 80 results in an amount of change in beam quality of 0.025, and when the temperature of the stress-applying portion 80 is 40° C., the largest compressive stress applied by the stress-applying portion 80 results in an amount of change in beam quality of 0.047.

Next, the graph indicated by the dotted line in FIG. 6 will be described. In this graph, the foregoing predetermined temperature is set to 35° C., for example. Therefore, in this case, the distribution of the external force is uniform in the peripheral direction of the cladding 53, and the amount of change in beam quality is zero. The temperature of the stress-applying portion 80 and the amount of change in beam quality in this case are described below.

When the temperature of the stress-applying portion 80 is 30° C., the tensile stress in the stress-applying portion 80 results in an amount of change in beam quality of 0.003, and when the temperature of the stress-applying portion 80 is 25° C., the larger tensile stress applied by the stress-applying portion 80 results in an amount of change in beam quality of 0.015. Furthermore, when the temperature of the stress-applying portion 80 is 40° C., the compressive stress of the stress-applying portion 80 results in an amount of change in beam quality of 0.007, when the temperature of the stress-applying portion 80 is 45° C., the larger compressive stress applied by the stress-applying portion 80 results in an amount of change in beam quality of 0.025, and when the temperature of the stress-applying portion 80 is 50° C., the largest compressive stress applied by the stress-applying portion 80 results in an amount of change in beam quality of 0.047.

Based on the above results, the lower the temperature of the stress-applying portion 80 is below a predetermined temperature, the greater the tensile stress, and because the distribution of the refractive index of the core 51 changes, there can be an increase in the amount of change in beam quality. In addition, the higher the temperature of the stress-applying portion 80 is above a predetermined temperature, the greater the compressive stress, and because the distribution of the refractive index of the core 51 changes, there can be an increase in the amount of change in beam quality. In other words, the magnitude of the stress is controlled by the temperature of the stress-applying portion 80, and the further the temperature of the stress-applying portion 80 is from a predetermined temperature, the greater the amount of change in beam quality can be. Thus, when the stress applied to the core 51 is controlled by temperature of the stress-applying portion 80, this control controls the beam quality in the optical fiber 50, whereby light of the desired beam quality is obtained.

For example, in the graph indicated by the solid line in FIG. 6, even if the predetermined temperature is, for example, 30° C., when the temperature of the stress-applying portion 80 is lower than this predetermined temperature, the stress-applying portion 80 contracts so as to apply a tensile stress, and when the temperature of the stress-applying portion 80 is higher than this predetermined temperature, the stress-applying portion 80 expands so as to apply a compressive stress. Therefore, no matter what the value of the predetermined temperature is, if the temperature of the stress-applying portion 80 changes relative to the predetermined temperature, the stress-applying portion 80 will contract or expand. Thus, it can be seen that because the distribution of the refractive index of the core 51 changes, the beam quality changes.

Next, the operation of the laser device 1 according to this embodiment will be described.

At the start of the operation of the laser device 1, the temperature of the stress-applying portion 80 and the temperature of the coating layer 55 are described as being at a predetermined temperature, and the stress-applying portion 80 and the coating layer 55 are not contracting or expanding, with no stress, such as tensile stress or compressive stress, being applied to the cladding 53. In this case, the distribution of the external force applied to the cladding 53 by the stress-applying portion 80 and the coating layer 55 is uniform in the peripheral direction of the cladding 53.

The operator operating the laser device 1 inputs the intended use of the laser device 1, such as shaving off or welding, into the input portion 113. The input portion 113 inputs this intended use to the temperature-controlling portion 90. The temperature control main body portion 91 accesses the storage portion 115 and reads the temperature of the stress-applying portion 80 corresponding to the intended use from a table stored in the storage portion 115. The temperature control main body portion 91 controls the voltage of the power supply 93 such that the temperature of the stress-applying portion 80 becomes the temperature read from the table. The power supply 93 applies a voltage to the Peltier element 95, causing the temperature of one side of the Peltier element 95 to rise or fall, and the temperature of the other side of the Peltier element 95 to fall or rise in a manner opposite to the one side.

When the temperature of the stress-applying portion 80 and the temperature of the coating layer 55 become lower than the predetermined temperature due to a drop in temperature of one side of the Peltier element 95, the stress-applying portion 80 and the coating layer 55 pull the cladding 53 through contraction, applying tensile stress to the cladding 53.

When the temperature of the stress-applying portion 80 and the temperature of the coating layer 55 become higher than the predetermined temperature due to a rise in temperature of one side of the Peltier element 95, the stress-applying portion 80 and the coating layer 55 press the cladding 53 through expansion, applying a compressive stress to the cladding 53.

The stress-applying portion 80 and the coating layer 55 impose a stress, namely a tensile stress, on the cladding 53 through contraction and a stress, namely a compressive stress, on the cladding 53 through expansion. As the temperature of the stress-applying portion 80 and the temperature of the coating layer 55 become lower than a predetermined temperature, the tensile stress increases. In addition, as the temperature of the stress-applying portion 80 and the temperature of the coating layer 55 become higher than the predetermined temperature, the compressive stress increases. The temperature of the stress-applying portion 80 and the temperature of the coating layer 55 are controlled according to the intended use of the laser device 1. The magnitude of the stress in the stress-applying portion 80 and the magnitude of the stress in the coating layer 55 are controlled by the temperature of the stress-applying portion 80 and the temperature of the coating layer 55.

In the laser device 1 according to this embodiment, the magnitude of the stress applied to the cladding 53 can change when the temperature of the stress-applying portion 80 and the temperature of the coating layer 55 change. When the magnitude of the stress changes, the external force applied to the cladding 53 by the stress-applying portion 80 and the coating layer 55 changes, and the distribution of the external force can become non-uniform in the peripheral direction of the cladding 53. Accordingly, the distribution of stress applied to the core 51 is non-uniform in the peripheral direction of the core 51, and the distribution of the refractive index of the core 51 may change and the mode of light propagating through the core 51 may change. The degree of change in the mode of light varies according to the intended use of the laser device 1.

Next, in each light source 2, pumping light is emitted from the respective laser diode 41 of the pumping light source 40. The pumping light emitted from the pumping light source 40 enters the inner cladding of the amplification optical fiber 30 via the pumping optical fiber 45 and the optical fiber 31. The pumping light incident on the inner cladding of the amplification optical fiber 30 mainly propagates through this inner cladding and pumps the active element added to the core when passing through the core of the amplification optical fiber 30. The active element, which is in a pumped state, emits spontaneous emission light, and light of some wavelengths of this spontaneous emission light is reflected by the first FBG 33, and of the reflected light, light of the wavelengths reflected by the second FBG 34 is reflected by the second FBG 34. Therefore, light is amplified through induced emission when light travels back and forth between the first FBG 33 and the second FBG 34, that is, inside the resonator 200, and propagates through the core of the amplification optical fiber 30, resulting in a laser oscillation state. The wavelength of the light at this time is set to 1070 nm, for example. A portion of the amplified light is then transmitted through the second FBG 34 and emitted from the optical fiber 32. This light passes from the optical fiber 21 and via the combiner 25 before entering the core of the delivery optical fiber 10.

If the delivery optical fiber 10 is a multi-mode fiber, the light entering the core of the delivery optical fiber 10 propagates through the core in multi-mode. The light propagating through the core is then propagated from the delivery optical fiber 10 to the optical fiber 50. Thus, the light amplified by the active element pumped by the pumping light propagates from the first FBG 33 to the optical fiber 31, the amplification optical fiber 30, the optical fibers 32, 21, the delivery optical fiber 10, and then the optical fiber 50.

The distribution of the refractive index of the core 51 of the optical fiber 50 is changed by the beam quality control device 70 according to the intended use of the laser device 1 such as cutting or shaving off, and the number of modes of light in the optical fiber 50 varies according to the intended use. Thus, for example, according to the intended use, single-mode light changes to multi-mode light, the number of modes of multi-mode light decreases, and multi-mode light changes to single-mode light. Therefore, the light has the desired beam quality according to the intended use. The light is then emitted from the emitting portion 60 with the desired beam quality according to the intended use and irradiated onto an object or the like. Note that the power of the light propagating through the core of each of the optical fibers 32, 21, 50 and the delivery optical fiber 10 is, for example, 1 kW or more.

As described hereinabove, the beam quality control device 70 according to this embodiment comprises: an optical fiber 50 having a core 51 and a cladding 53 that surrounds the outer peripheral surface of the core 51; a stress-applying portion 80 that is in surface contact with at least a portion of the outer peripheral surface of the optical fiber 50 and has a coefficient of thermal expansion different from the coefficient of thermal expansion of the cladding 53; and a temperature-controlling portion 90 that controls the temperature of the stress-applying portion 80. The stress-applying portion 80 contracts or expands due to the temperature of the stress-applying portion 80 being changed by the temperature-controlling portion 90 such that the distribution of the external force applied by the stress-applying portion 80 to the cladding 53 becomes non-uniform in the peripheral direction of the cladding 53.

In the beam quality control device 70 according to this embodiment, the stress-applying portion 80 contracts or expands when the temperature of the stress-applying portion 80 is changed by the temperature-controlling portion 90. As the stress-applying portion 80 contracts or expands, the external force applied by the stress-applying portion 80 to the cladding 53 changes non-uniformly in the peripheral direction of the cladding 53. If the external force changes non-uniformly, the distribution of stress applied to the core 51 becomes non-uniform in the peripheral direction of the core 51, the distribution of the refractive index of the core 51 changes, and the mode of light propagating through the core 51 may change. Furthermore, in the beam quality control device 70 according to this embodiment, a coating layer 55 is disposed, and the coating layer 55 can further change the distribution of the refractive index of the core 51 and change the mode of the light propagating through the core 51. Thus, in the beam quality control device 70 according to this embodiment, the stress applied to the core 51 is controlled by the temperature, whereby light of the desired beam quality is obtained. In addition, because the beam quality is controlled in the optical fiber 50 in the beam quality control device 70 according to this embodiment, unintended changes in the beam quality can be suppressed in comparison with a case where the beam quality is controlled by arranging a glass member or a lens in space, even when vibrations or changes in environmental temperature, and so forth, occur as described above. Therefore, with this beam quality control device 70 according to this embodiment, light of the desired beam quality can be obtained.

Furthermore, the beam quality control device 70 according to this embodiment further comprises a plate-shaped heat-conducting member 111 on the main surface of which the stress-applying portion 80 is disposed, which is thermally connected to the stress-applying portion 80 and the temperature-controlling portion 90, and which conducts heat between the temperature-controlling portion 90 and the stress-applying portion 80.

When the temperature-controlling portion 90 generates heat, the heat of the temperature-controlling portion 90 can easily be conducted across the entire heat-conducting member 111 in the planar direction of the heat-conducting member 111, and can easily be conducted from the heat-conducting member 111 to the stress-applying portion 80 on the main surface of the heat-conducting member 111. Additionally, when the temperature-controlling portion 90 absorbs heat, the heat of the stress-applying portion 80 can be easily conducted across the entire heat-conducting member 111 in the planar direction of the heat-conducting member 111, and can be easily conducted from the stress-applying portion 80 to the heat-conducting member 111. Accordingly, the temperature of the stress-applying portion 80 readily changes, and the magnitude of the stress on the stress-applying portion 80 can easily change according to the temperature of the stress-applying portion 80. Therefore, with this beam quality control device 70, the magnitude of the stress in the stress-applying portion 80 can be more easily changed than when the heat-conducting member 111 is not in place.

Furthermore, in the beam quality control device 70 according to this embodiment, the temperature-controlling portion 90 includes a Peltier element 95 thermally connected to the heat-conducting member 111.

In general, when current flows in a predetermined direction in the Peltier element 95, the temperature of one side of the Peltier element 95 rises, and the temperature of the other side falls. In this case, when the heat-conducting member 111 is disposed on one side, heat is transferred from one side to the stress-applying portion 80 via the heat-conducting member 111, and the temperature of the stress-applying portion 80 is raised by the Peltier element 95. Furthermore, when the current flows in the opposite direction to the foregoing direction, the temperature of one side falls and the temperature of the other side rises. In this case, when the heat-conducting member 111 is disposed on one side, heat is transferred from the stress-applying portion 80 to the Peltier element 95 via the heat-conducting member 111, and the temperature of the stress-applying portion 80 is lowered by the Peltier element 95. Thus, the temperature of the stress-applying portion 80 changes according to the direction of the current flowing in the Peltier element 95, and the magnitude of the stress in the stress-applying portion 80 can be controlled by the temperature of the stress-applying portion 80. Therefore, with this beam quality control device 70, the magnitude of the stress in the stress-applying portion 80 can be controlled by the Peltier element 95.

Further, in the beam quality control device 70 according to this embodiment, the stress-applying portion 80 is made of a resin with a non-uniform thickness between the contact surface, which is in surface contact with the outer peripheral surface of the optical fiber 50, and the outer peripheral surface of the stress-applying portion 80, which is spaced apart from the contact surface.

In this case, variations in the temperature of the resin can cause inconsistency in the magnitude of the external force applied to the cladding 53, and the distribution of stress applied to the core 51 can be non-uniform in the peripheral direction of the core 51.

Furthermore, in the beam quality control device 70 according to this embodiment, when the temperature of the resin is lower than a predetermined temperature, the resin contracts so as to apply a tensile stress to the cladding 53, and when the temperature of the resin is higher than the predetermined temperature, the resin expands so as to apply a compressive stress to the cladding 53.

In this case, the temperature-controlling portion 90 can control the contraction or expansion of the resin by controlling the temperature of the resin, and can control the stress through contraction or expansion of the resin.

The laser device 1 according to this embodiment comprises a beam quality control device 70 and a light source 2 that emits light. Light propagates through the core 51 of the optical fiber 50 of the beam quality control device 70.

In this case, the laser device 1 is capable of irradiating the object with light of a beam quality that is controlled by the beam quality control device 70. In addition, as described above, with this beam quality control device 70, light of the desired beam quality is obtained even when vibration or changes in environmental temperature, or the like, occur. Thus, light of the desired beam quality can irradiate the object.

The laser device 1 according to this embodiment also comprises a beam quality control device 70 and a pumping light source 40 that emits pumping light. Light amplified by the active element pumped by the pumping light propagates through the optical fiber 50 of the beam quality control device 70.

In this case, the laser device 1 is capable of irradiating the object with light of a beam quality that is controlled by the beam quality control device 70. In addition, as described above, with this beam quality control device 70, light of the desired beam quality is obtained even when vibration or changes in environmental temperature, or the like, occur. Thus, light of the desired beam quality can irradiate the object.

Further, the laser device 1 according to this embodiment comprises: an amplification optical fiber 30 to which an active element is added; a first FBG 33 that is provided on one side of the amplification optical fiber 30 and that reflects light of at least some wavelengths of the light amplified by the active element; a second FBG 34 that is provided on the other side of the amplification optical fiber 30 and that reflects light of at least some wavelengths of the light reflected by the first FBG 33 at a lower reflectance than the first FBG 33; and an emitting portion 60 that emits light transmitted through the second FBG 34 toward the object. The beam quality control device 70 is disposed between the emitting portion 60 and the area of the second FBG which is farthest from the connection point between the amplification optical fiber 30 and the optical fiber 32.

This configuration may make it easier to bring the beam quality of the light emitted from the emitting portion 60 closer to the desired beam quality than when the beam quality control device 70 is placed at a location other than between the above farthest part and the emitting portion 60.

Further, the laser device 1 according to this embodiment comprises: an input portion 113 that inputs the intended use of the laser device 1 to the temperature-controlling portion 90; and a storage portion 115 that stores the temperature of the stress-applying portion according to the intended use, wherein the temperature-controlling portion 90 controls the temperature of the stress-applying portion 80 to the temperature of the stress-applying portion 80 read from the storage portion 115 when the intended use is inputted from the input portion 113.

In this case, because the degree of change in the mode of the light varies according to the intended use of the laser device 1, the laser device 1 can irradiate an object with light of a beam quality suitable for each intended use. Accordingly, the processing performance of the laser device 1, such as the processing speed and processing quality thereof, can be improved in comparison with a case where light of a beam quality suitable for each intended use is not irradiated onto an object.

### Second Embodiment

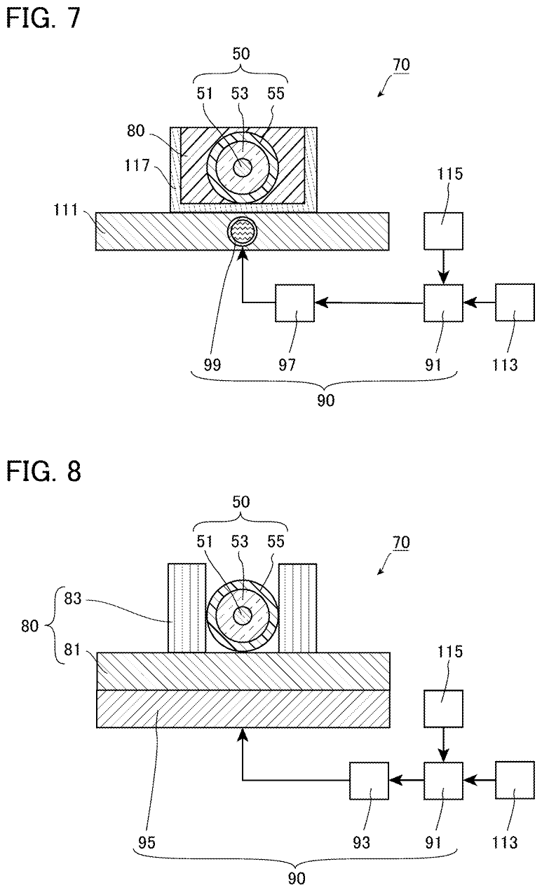

Next, a second embodiment of the present invention will be described in detail with reference to FIG. 7. Note that, for constituent elements that are identical or equivalent to those of the first embodiment, the same reference signs are used and redundant descriptions are omitted, unless stated otherwise.

FIG. 7 is a diagram illustrating a beam quality control device 70 according to this embodiment. The beam quality control device 70 according to this embodiment differs from the beam quality control device 70 of the first embodiment in that the configuration of the temperature-controlling portion 90 differs from the configuration of the temperature-controlling portion 90 according to the first embodiment, and in that the beam quality control device 70 further comprises a frame member 117.

The temperature-controlling portion 90 according to this embodiment includes a temperature control main body portion 91, a heat pump 97, and a flow passage 99.

The heat pump 97 cools or heats the fluid flowing through the flow passage 99 under the control of the temperature control main body portion 91. The temperature of the heat pump 97 is controlled by the temperature control main body portion 91.

The flow passage 99 penetrates the heat-conducting member 111 and is disposed directly below the optical fiber 50. The flow passage 99 is thermally connected to the heat-conducting member 111. The flow passage 99 is a pipe or other tube, for example. Fluid flows in the flow passage 99, and this fluid is a liquid, for example. The flow passage 99 extends outside the heat-conducting member 111 and is thermally connected to the heat pump 97 outside the heat-conducting member 111. The temperature of the fluid varies according to the heat from the heat pump 97. The flow passage 99 is not necessarily disposed directly below the optical fiber 50, but should be disposed so as to be thermally connected to the heat-conducting member 111.

Furthermore, in the beam quality control device 70 according to this embodiment, the frame member 117 is made of metal, for example. The frame member 117 is placed on the heat-conducting member 111 and is thermally connected to the heat-conducting member 111.

The cross-section of the frame member 117 is concave, and the stress-applying portion 80 and the optical fiber 50 are arranged inside the concave frame member 117. The stress-applying portion 80, which surrounds the optical fiber 50 over the entire circumference thereof, is in contact with the inner peripheral surface of the frame member 117 and is thermally connected to the frame member 117. The frame member 117 surrounds the stress-applying portion 80, which is resin. The frame member 117 should surround at least a portion of the stress-applying portion 80. The height of the inner side in the concave cross-section of the frame member 117 is longer than the diameter of the optical fiber 50. The frame member 117 fixes the stress-applying portion 80 to the optical fiber 50. The coefficient of thermal expansion of the frame member 117 is smaller than the coefficient of thermal expansion of the stress-applying portion 80. Further, when the stress-applying portion 80 expands, the frame member 117 suppresses the spread of the stress-applying portion 80 toward the frame member 117.

In the beam quality control device 70 according to this embodiment, the temperature-controlling portion 90 includes a heat pump 97; and a flow passage 99 through which a fluid whose temperature is changed by the heat pump 97 flows, which penetrates the heat-conducting member 111, and which changes the temperature of the stress-applying portion 80 using the fluid. Further, in the beam quality control device 70 according to this embodiment, the stress-applying portion 80 is thermally connected to the flow passage 99 via the frame member 117 and the heat-conducting member 111. As the heat pump 97 controls the temperature of the fluid through cooling or heating, the temperature of the stress-applying portion 80 is changed by the fluid via the heat-conducting member 111, and the magnitude of the stress in the stress-applying portion 80 can be controlled by the temperature of the stress-applying portion 80. Therefore, with this beam quality control device 70, the magnitude of the stress in the stress-applying portion can be controlled by the fluid flowing through the flow passage 99.

Further, the beam quality control device 70 according to this embodiment further comprises a frame member 117 that surrounds at least a portion of the stress-applying portion 80, wherein the coefficient of thermal expansion of the frame member 117 is smaller than the coefficient of thermal expansion of the stress-applying portion 80.

In this case, the stress-applying portion 80 can press the cladding 53 with a stronger external force toward the cladding 53 than when the frame member 117 is not in place, because upon expansion, the frame member 117 suppresses the spread toward the frame member 117. Accordingly, the stress-applying portion 80 is capable of applying a larger compressive stress to the cladding 53 than when the frame member 117 is not in place.

Furthermore, in the beam quality control device 70 according to this embodiment, the frame member 117 is made of metal.

In general, heat can be easily conducted via the frame member 117 to the stress-applying portion 80 because heat is readily conducted through metal. Therefore, with the beam quality control device 70 according to this embodiment, the stress of the stress-applying portion 80 can change faster than when the frame member 117 is not in place.

Note that the heat of the fluid is also conducted to the frame member 117 via the heat-conducting member 111. The coefficient of thermal expansion of the frame member 117 is lower than the coefficient of thermal expansion of the stress-applying portion 80. Therefore, the contraction or expansion of the frame member 117 due to heat has little effect on the contraction or expansion of the stress-applying portion 80.

### Third Embodiment

Next, a third embodiment of the present invention will be described in detail with reference to FIG. 8. Note that, for constituent elements that are identical or equivalent to those of the first embodiment, the same reference signs are used and redundant descriptions are omitted, unless stated otherwise.

FIG. 8 is a diagram illustrating a beam quality control device 70 according to this embodiment. With the beam quality control device 70 according to this embodiment, the configuration of the stress-applying portion 80 differs from the configuration of the stress-applying portion 80 according to the first embodiment.

The stress-applying portion 80 according to this embodiment includes a plate member 81, and a pair of wall members 83 that stand upright on the plate member 81.

The plate member 81 is made of metal such as copper, for example. The plate member 81 is placed on the Peltier element 95 and is thermally connected to the Peltier element 95. The plate member 81 contracts or expands in the alignment direction of the pair of wall members 83 by the heat conducted from the Peltier element 95. The coefficient of thermal expansion of the plate member 81 is greater than the coefficient of thermal expansion of the cladding 53. The plate member 81 may also be a heat-conducting member 111 according to the first embodiment.

The wall members 83 are made of metal, for example. The wall members 83 are fixed to the plate member 81. The pair of wall members 83 sandwich the optical fiber 50 in the radial direction and are in contact with the optical fiber 50.

In the state where the temperature of the plate member 81 is at a certain predetermined temperature, the plate member 81 does not contract or expand, and the wall members 83 only make contact with the optical fiber 50 by sandwiching the optical fiber 50. Therefore, the plate member 81 is in a state of not applying stress, such as compressive stress, to the cladding 53 via the wall members 83. In this case, the distribution of the external force applied to the cladding 53 by the stress-applying portion 80 is uniform in the peripheral direction of the cladding 53.

For example, when the temperature of one side of the Peltier element 95 of the temperature-controlling portion 90 falls and the temperature of the other side rises, the heat of the plate member 81 is conducted to the Peltier element 95 via the heat-conducting member 111. Accordingly, the temperature of the plate member 81 falls below the predetermined temperature, and the plate member 81 contracts in comparison with when same is at the predetermined temperature. In addition, because the coefficient of thermal expansion of the plate member 81 is greater than the coefficient of thermal expansion of the cladding 53, the plate member 81 contracts to a greater extent than the cladding 53. At this time, the plate member 81 contracts in the direction of alignment of the pair of wall members 83. Accordingly, the pair of wall members 83 are brought close to each other. The pair of wall members 83 can then press the cladding 53 from both sides in the radial direction of the cladding 53 and can apply a compressive stress to the cladding 53.

For example, when the temperature of one side of the Peltier element 95 of the temperature-controlling portion 90 rises and the temperature of the other side falls, the heat of the Peltier element 95 is conducted to the plate member 81 via the heat-conducting member 111. Accordingly, the temperature of the plate member 81 rises above the temperature during contraction, and the plate member 81 expands more than during contraction. In addition, because the coefficient of thermal expansion of the plate member 81 is greater than the coefficient of thermal expansion of the cladding 53, the plate member 81 expands to a greater extent than the cladding 53. At this time, the plate member 81 expands in the direction of alignment of the pair of wall members 83. Accordingly, the pair of wall members 83 move away from each other. The pair of wall members 83 can then release the application of a compressive stress during contraction.

Thus, the pair of wall members 83 are capable of applying a compressive stress, which is stress from both sides in the radial direction of the cladding 53, to the cladding 53 through contraction, and of releasing the application of the compressive stress through expansion. As a result, the distribution of stress applied to the core 51 becomes non-uniform in the peripheral direction of the core 51, and the mode of the light propagating through the core 51 can change. Thus, light of the desired beam quality is obtained also with the beam quality control device 70 according to this embodiment.

### Fourth Embodiment

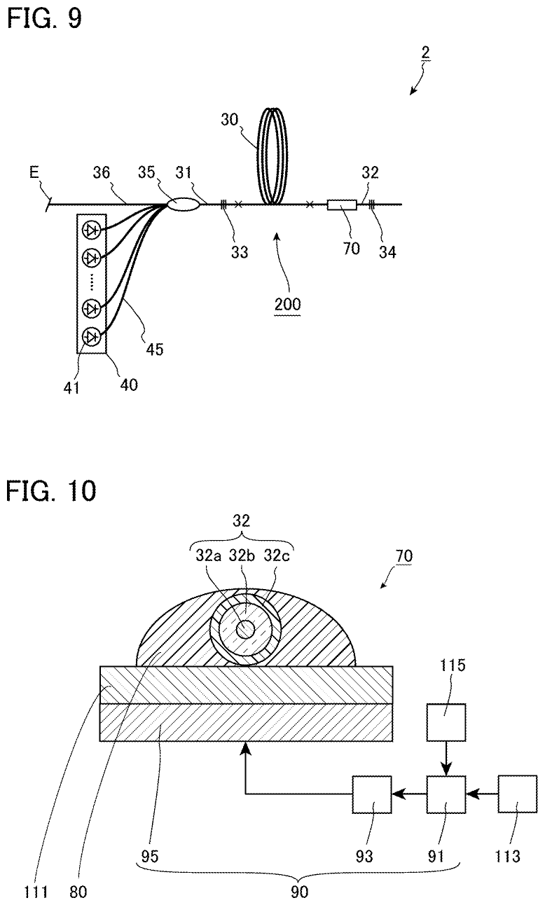

Next, a fourth embodiment of the present invention will be described in detail with reference to FIGS. 9 and 10. Note that, for constituent elements that are identical or equivalent to those of the first embodiment, the same reference signs are used and redundant descriptions are omitted, unless stated otherwise.

FIG. 9 is a diagram illustrating a light source 2 in a laser device 1 according to this embodiment. Further, FIG. 10 is a diagram illustrating a beam quality control device of the light source of FIG. 9. In the laser device 1 according to this embodiment, the location of the beam quality control device 70 and the configuration of the beam quality control device 70 are different from those of the first embodiment.

The beam quality control device 70 according to this embodiment is disposed inside the resonator 200 in each light source 2. As described above, the resonator 200 is constituted by an amplification optical fiber 30, a first FBG 33, and a second FBG 34. In the light source 2 according to this embodiment, an example is illustrated in which the beam quality control device 70 is disposed between the connection point between the amplification optical fiber 30 and the optical fiber 32, and the area of the second FBG 34 which is farthest from the connection point. The second FBG 34 has a configuration in which a high refractive index portion with a higher refractive index than the refractive index of the core of the optical fiber 32 and a low refractive index portion with a refractive index equivalent to the refractive index of the core of the optical fiber 32 are alternately repeated. The foregoing farthest part is the high refractive index portion of the second FBG 34 which is farthest from the connection point.

An example is illustrated in which the beam quality control device 70 according to this embodiment includes the optical fiber 32, as illustrated in FIG. 10, instead of the optical fiber 50 illustrated in FIG. 3 and so forth. For example, the core 32a of the optical fiber 32 has the same configuration as the core 51 of the optical fiber 50, the cladding 32b of the optical fiber 32 has the same configuration as the cladding 53 of the optical fiber 50, and the coating layer 32c of the optical fiber 32 has the same configuration as the coating layer 55 of the optical fiber 50.

Furthermore, the beam quality control device 70 according to this embodiment includes a stress-applying portion 80, a temperature-controlling portion 90, a heat-conducting member 111, an input portion 113, and a storage portion 115, similarly to the beam quality control device 70 according to the first embodiment. However, the temperature control main body portion 91 and the power supply 93 of the temperature-controlling portion 90, the input portion 113, and the storage portion 115 may be shared by the beam quality control device 70 of each light source 2.

The beam quality control device 70 according to this embodiment includes an optical fiber 32 instead of the optical fiber 50 as described above, and therefore the stress-applying portion 80 according to this embodiment surrounds the outer peripheral surface of the coating layer 32c of the optical fiber 32 over the entire circumference thereof and gaplessly adheres to the outer peripheral surface of the coating layer 32c, making surface contact with the outer peripheral surface. The stress-applying portion 80 that surrounds the optical fiber 32 as described above has the same configuration as the stress-applying portion 80 according to the first embodiment that surrounds the optical fiber 50. A second FBG 34 is also provided to the optical fiber 32 of the beam quality control device 70 according to this embodiment. The stress-applying portion 80 is disposed between the connection point between the amplification optical fiber 30 and the optical fiber 32, and the area of the second FBG 34 which is farthest from the connection point.

The stress-applying portion 80 according to this embodiment can contract or expand according to the temperature of the stress-applying portion 80, and can apply stress, namely a tensile stress, to the cladding 32b, through contraction, and can apply stress, namely a compressive stress, to the cladding 32b, through expansion. Further, the coating layer 32c of the optical fiber 32 can contract or expand according to the temperature of the coating layer 32c, and can apply stress, namely a tensile stress, to the cladding 32b, through contraction, and can apply stress, namely a compressive stress, to the cladding 32b, through expansion.

The magnitude of stress, such as the foregoing compressive stress and tensile stress, varies according to the temperature of the stress-applying portion 80 and the coating layer 32c. As the magnitude of the stress changes, the external force applied to the cladding 32b by the stress-applying portion 80 and the coating layer 32c changes, and the distribution of the external force in the cladding 32b becomes non-uniform in the peripheral direction of the cladding 32b. Accordingly, the distribution of stress applied to the core 32a is non-uniform in the peripheral direction of the core 32a, and the distribution of the refractive index of the core 32a may change and the mode of light propagating through the core 32a may change.

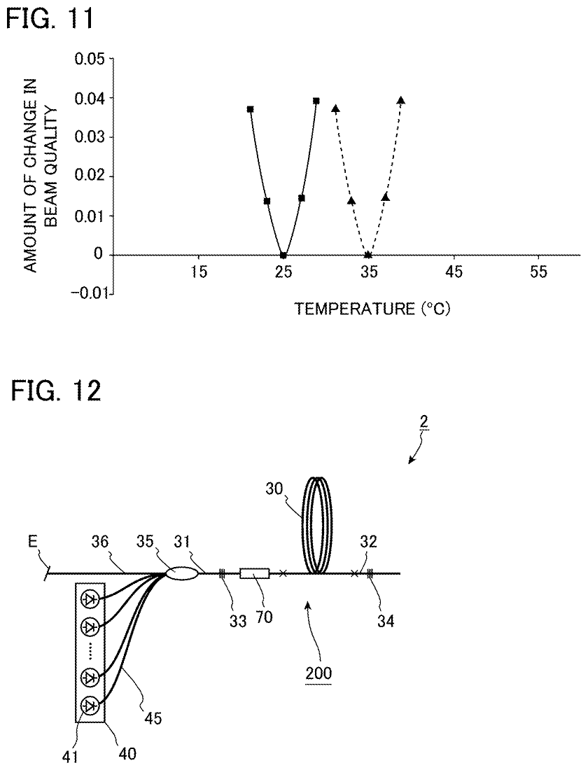

Next, using FIG. 11, an example of the relationship between the temperature of the stress-applying portion 80 according to this embodiment, which is controlled by the temperature-controlling portion 90, and the amount of change in beam quality, will be described. FIG. 11 is a diagram illustrating an example of the relationship between the temperature of the stress-applying portion 80 according to this embodiment and the amount of change in beam quality.

Here, the graph indicated by the solid line in FIG. 11 will now be described. In this graph, the predetermined temperature is set to 25° C., for example. Therefore, in this case, the distribution of the external force is uniform in the peripheral direction of the cladding 32b, and the amount of change in beam quality is zero. The temperature of the stress-applying portion 80 and the amount of change in beam quality in this case are described below.

When the temperature of the stress-applying portion 80 is 22° C., the tensile stress in the stress-applying portion 80 results in an amount of change in beam quality of 0.013, and when the temperature of the stress-applying portion 80 is 20° C., the larger tensile stress applied by the stress-applying portion 80 results in an amount of change in beam quality of 0.039. Further, when the temperature of the stress-applying portion 80 is 27° C., the compressive stress in the stress-applying portion 80 results in an amount of change in beam quality of 0.015, and when the temperature of the stress-applying portion 80 is 30° C., the larger compressive stress applied by the stress-applying portion 80 results in an amount of change in beam quality of 0.040.

Next, the graph indicated by the dotted line in FIG. 11 will be described. In this graph, the predetermined temperature is set to 35° C., for example. Therefore, in this case, the distribution of the external force is uniform in the peripheral direction of the cladding 32b, and the amount of change in beam quality is zero. The temperature of the stress-applying portion 80 and the amount of change in beam quality in this case are described below.

When the temperature of the stress-applying portion 80 is 32° C., the tensile stress in the stress-applying portion 80 results in an amount of change in beam quality of 0.013, and when the temperature of the stress-applying portion 80 is 31° C., the larger tensile stress applied by the stress-applying portion 80 results in an amount of change in beam quality of 0.039. Further, when the temperature of the stress-applying portion 80 is 37° C., the compressive stress in the stress-applying portion 80 results in an amount of change in beam quality of 0.015, and when the temperature of the stress-applying portion 80 is 40° C., the larger compressive stress applied by the stress-applying portion 80 results in an amount of change in beam quality of 0.040.

From the results described above, the magnitude of the stress applied to the core 32a is controlled by the temperature of the stress-applying portion 80, as in the case described using FIG. 6 in the first embodiment, and the amount of change in beam quality can increase as the temperature of the stress-applying portion 80 moves away from a predetermined temperature. Further, when the stress applied to the core 32a is controlled as described above, the beam quality is controlled in the optical fiber 32, and light of the desired beam quality is obtained.

Furthermore, as in the case described in the first embodiment using FIG. 6, in the stress-applying portion 80 according to this embodiment, the stress-applying portion 80 contracts or expands when the temperature of the stress-applying portion 80 changes relative to the predetermined temperature, no matter what the value of the predetermined temperature is. Thus, it can be seen that because the distribution of the refractive index of the core 32a varies and the mode of the light propagated through the core 32a changes, the beam quality changes.

Next, the graph according to this embodiment, as indicated by a solid line in FIG. 11, will be compared with the graph according to the first embodiment, as indicated by a solid line in FIG. 6. Comparing the two graphs, the graph in FIG. 11 is steeper than the graph in FIG. 6. Therefore, if the temperature of the stress-applying portion 80 changes by the same temperature in this embodiment and the first embodiment, respectively, relative to a predetermined temperature, the amount of change in beam quality according to this embodiment is larger than the amount of change in beam quality according to the first embodiment. In other words, it can be seen that, due to being disposed inside the resonator 200, the beam quality control device 70 according to this embodiment can obtain a larger amount of change in beam quality than the beam quality control device 70 according to the first embodiment, even with the same temperature change as the beam quality control device 70 according to the first embodiment. In other words, because the beam quality control device 70 according to this embodiment is disposed inside the resonator 200, it can be seen that the same amount of change in beam quality as the beam quality control device 70 according to the first embodiment can be obtained with less temperature change than the beam quality control device 70 according to the first embodiment. Furthermore, it can be seen that, for the dotted line graphs in FIGS. 11 and 6, respectively, as per the solid line graphs in FIGS. 11 and 6, respectively, the beam quality control device 70 according to this embodiment can obtain a larger amount of change in beam quality than the beam quality control device 70 according to the first embodiment, even with the same temperature change as the beam quality control device 70 according to the first embodiment.

As a result, the beam quality of the beam quality control device 70 according to this embodiment can change more significantly than that of the beam quality control device 70 according to the first embodiment, even with the same temperature change as that of the beam quality control device 70 according to the first embodiment. In addition, when obtaining light of the same beam quality as the beam quality control device 70 according to the first embodiment, the beam quality control device 70 according to this embodiment can obtain light of the desired beam quality in a short time because the temperature change is less than that of the beam quality control device 70 according to the first embodiment.

Next, the operation of the laser device 1 according to this embodiment will be described.

If the temperature of the stress-applying portion 80 and the temperature of the coating layer 32c changes from a predetermined temperature, the magnitude of the stress applied to the cladding 32b can change. As the magnitude of the stress applied to the cladding 32b changes, the external force applied to the cladding 32b by the stress-applying portion 80 and the coating layer 32c changes, and the distribution of the external force becomes non-uniform in the peripheral direction of the cladding 32b. Accordingly, the distribution of stress applied to the core 32a is non-uniform in the peripheral direction of the core 32a, and the distribution of the refractive index of the core 32a may change and the mode of light propagating through the core 32a may change. The degree of change in the mode of light varies according to the intended use of the laser device 1. When the distribution of the refractive index of the core 32a changes as described above, the laser device 1 operates as follows.

The pumping light emitted from the pumping light source 40 enters the inner cladding of the amplification optical fiber 30 via the pumping optical fiber 45 and the optical fiber 31. This pumping light propagates mainly through the inner cladding and pumps the active element added to the core upon passing through the core of the amplification optical fiber 30. The active element, which is in a pumped state, emits spontaneous emission light, and light of some wavelengths of this spontaneous emission light is reflected by the first FBG 33, and of the reflected light, light of the wavelengths reflected by the second FBG 34 is reflected by the second FBG 34. Therefore, the light travels back and forth between the first FBG 33 and the second FBG 34, that is, inside the resonator 200.

The stress-applying portion 80 according to this embodiment is disposed inside the resonator 200 between the connection point between the amplification optical fiber 30 and the optical fiber 32, and the area of the second FBG 34 which is farthest from the connection point. Furthermore, the distribution of the refractive index of the core 32a is varied by the beam quality control device 70 according to the intended use of the laser device 1, such as cutting or shaving off. Therefore, each time light travels back and forth inside the resonator 200, same propagates through the core 32a, and each time same travels back and forth, the number of modes of light in the optical fiber 32 changes according to the intended use. Thus, for example, according to the intended use, single-mode light changes to multi-mode light, the number of modes of multi-mode light decreases, and multi-mode light changes to single-mode light. In addition, the beam quality of the light according to this embodiment can vary greatly in comparison with a case where the beam quality control device 70 is disposed outside the resonator 200, and light of the desired beam quality that corresponds to the intended use can be obtained. Further, each time the light travels back and forth inside the resonator 200, the beam quality control device 70 controls the beam quality. With the desired beam quality according to the intended use, the light is then transmitted through the second FBG 34, propagated through the optical fiber 32, the optical fiber 21, the combiner 25, and then the core of the delivery optical fiber 10, and irradiated from the emitting portion 60 onto an object or the like.

Incidentally, in the laser devices of Patent Literature 1 and Patent Literature 2, the light does not travel back and forth between the upstream and downstream optical fibers, and the beam quality is controlled only once by the position and orientation of the glass members and lenses. There is a concern that it will be difficult to obtain light of the desired beam quality by means of one control operation.

Therefore, the laser device 1 according to this embodiment further comprises the resonator 200 in which the light amplified by the active element pumped by the pumping light resonates, and the beam quality control device 70 is disposed inside the resonator 200.

In this laser device 1, the light propagates through the core 32a of the beam quality control device 70 each time same travels back and forth inside the resonator 200, and the mode of the light can be changed in the optical fiber 32 each time same travels back and forth, thereby obtaining light of the desired beam quality. Furthermore, with the laser device 1 according to this embodiment, the beam quality can be changed significantly in comparison with a case where the beam quality control device 70 is disposed outside the resonator 200, and light of the desired beam quality can be obtained. Further, in the laser device 1, when the state of the optical fiber changes according to the intended use of the laser device 1, the degree of change in the mode of the light changes according to the intended use of the laser device 1, and hence light of the desired beam quality that corresponds to the intended use is obtained.

In addition, in the laser device 1 according to this embodiment, even if the degree of change in the mode of the light when the light passes through the beam quality control device 70 once is smaller than in a case where the beam quality control device is disposed outside the resonator 200, the amount of change in the beam quality of the light emitted from the laser device 1 can be the same as the amount of change in the beam quality in a case where the beam quality control device is disposed outside the resonator 200, due to the back and forth travel of the light. Therefore, when the beam quality of the light emitted from the laser device 1 is changed from a predetermined state to another state, the amount of change in the distribution of the refractive index of the core 32a of the laser device 1 according to this embodiment is smaller than the amount of change in the distribution of the refractive index of the core 32a when the beam quality control device is disposed outside the resonator 200. As a result, with the laser device 1 according to this embodiment, the time for the change in the distribution of the refractive index of the core 32a can be shortened in comparison with a case where the beam quality control device is disposed outside the resonator 200, and the light can be changed to the desired beam quality in a short time.

Next, a case will be described in which the amount of change in beam quality obtained by the beam quality control device 70 disposed inside the resonator 200 is to be obtained by a beam quality control device disposed outside the resonator 200. In this case, there is a concern that there will be an increase in the number of beam quality control devices arranged outside the resonator 200 in comparison with beam quality control devices 70 disposed inside the resonator 200, and that the length of the optical fiber where the stress-applying portion is disposed will be longer, or the like. Therefore, if the beam quality control device 70 is disposed outside the resonator 200, there is a concern that the beam quality control device 70 will increase in size and have a higher cost, and so forth. However, because the beam quality control device 70 according to this embodiment is disposed inside the resonator 200, an increased size and higher cost of the beam quality control device 70 will be suppressed, and so forth. Therefore, an increased size and higher cost of the overall laser device 1 will be suppressed.

Furthermore, in this laser device 1 according to this embodiment, the stress applied to the core 32a is controlled by temperature so as to obtain light of the desired beam quality. In addition, in the beam quality control device 70 according to this embodiment, because the beam quality is controlled in the optical fiber 32, unintended changes in the beam quality can be suppressed in comparison with a case where the beam quality is controlled by arranging a glass member or a lens in space, even when vibrations or changes in environmental temperature, or the like, occur. Therefore, with this beam quality control device 70 according to this embodiment, light of the desired beam quality can be obtained.

Further, in the laser device 1 according to this embodiment, the resonator 200 includes: an amplification optical fiber 30 to which an active element is added; a first FBG 33 that is provided on one side of the amplification optical fiber 30 and that reflects light of at least some wavelengths of the light amplified by the active element; and a second FBG 34 that is provided on the other side of the amplification optical fiber 30 and that reflects light of at least some wavelengths of the light reflected by the first FBG 33 at a lower reflectance than the first FBG 33. In addition, the beam quality control device 70 is disposed between the connection point between the amplification optical fiber 30 and the optical fiber 32, and the area of the second FBG 34 which is farthest from that connection point.

The power density of light between the connection point and the area of the second FBG 34 which is farthest from the connection point is higher than the power density of the light in other areas between the first FBG and the second FBG. Therefore, when the beam quality control device 70 is disposed between the connection point and this area, the beam quality may vary more significantly than when same is disposed in other areas between the first FBG and the second FBG, and it may be easier to bring the beam quality of the light emitted from the emitting portion 60 closer to the desired beam quality. Further, the beam quality control device 70 may make it easier to bring light with a high power density closer to the desired beam quality than when same is disposed in another area, and may make it easier to bring the beam quality of light emitted from the emitting portion 60 closer to the desired beam quality.

Note that the stress-applying portion 80 may surround the outer peripheral surface of the coating layer 32c of the optical fiber 32 in the section where the second FBG 34 is located, over the entire circumference of this surface, and may gaplessly adhere to the outer peripheral surface of the coating layer 32c so as to be in surface contact with the outer peripheral surface.

Note that, in the light source 2 of a modification example of this embodiment, the beam quality control device 70 may be disposed between the connection point between the amplification optical fiber 30 and the optical fiber 31, and the area of the first FBG 33 which is farthest from the connection point, as illustrated in FIG. 12. The optical fiber 31 is the optical fiber of the beam quality control device 70, and the optical fiber 31 comprises the first FBG 33. The stress-applying portion 80 is disposed between the above-described connection point and the area of the first FBG 33 which is farthest from the connection point. In FIG. 12, the stress-applying portion 80 is omitted for easy viewing. The coefficient of thermal expansion of the inner cladding of the optical fiber 31 according to the modification example is the same as the coefficient of thermal expansion of the cladding 53 according to the first embodiment, and the coefficient of thermal expansion of the coating layer of the optical fiber 31 according to the modification example is the same as the coefficient of thermal expansion of the coating layer 55 according to the first embodiment. Further, the coefficient of thermal expansion of the outer cladding of the optical fiber 31 according to the modification example is smaller than the coefficient of thermal expansion of the inner cladding of the optical fiber 31 according to the modification example and that of the coating layer of the optical fiber 31 according to the modification example. This contraction or expansion of the outer cladding has little effect on the contraction or expansion of the inner cladding, and little effect on the contraction or expansion of the stress-applying portion 80.

The first FBG 33 has a configuration in which a high refractive index portion with a higher refractive index than the refractive index of the core surrounded by the cladding of the optical fiber 31, and a low refractive index portion with a refractive index equivalent to the refractive index of the core, are alternately repeated. The foregoing farthest part is the high refractive index portion of the first FBG 33 which is farthest from the connection point.

The power density of light between the connection point and the area of the first FBG 33 which is farthest from the connection point is lower than the power density of other areas between the first FBG and the second FBG. Therefore, when the beam quality control device 70 is disposed between the connection point and this area, heat generation in the optical fiber 31 of the beam quality control device 70 can be suppressed in comparison with a case where the device is disposed in another area between the first FBG and the second FBG. Therefore, damage to the beam quality control device 70 can be suppressed.

Note that the stress-applying portion 80 may surround the outer peripheral surface of the coating layer of the optical fiber 31 in the section where the first FBG 33 is located, over the entire circumference of this surface, and may gaplessly adhere to the outer peripheral surface of the coating layer so as to be in surface contact with the outer peripheral surface.

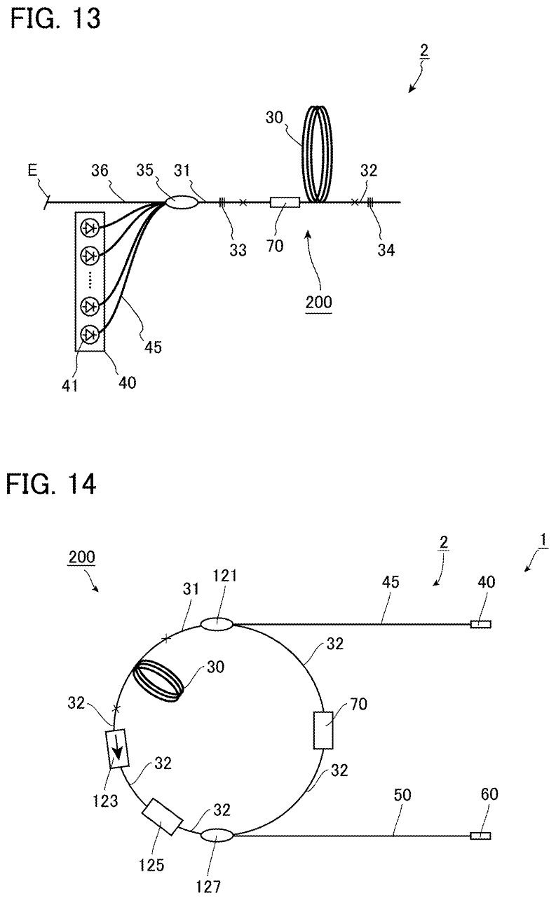

Alternatively, in a light source 2 of another modification example according to this embodiment, the amplification optical fiber 30 may also be the optical fiber of the beam quality control device 70, as illustrated in FIG. 13. The stress-applying portion 80 is disposed between a winding portion of the amplification optical fiber 30, and the connection point between the amplification optical fiber 30 and the optical fiber 31. In FIG. 13, the stress-applying portion 80 is omitted for easy viewing. Note that the stress-applying portion 80 may also be disposed on the winding portion of the amplification optical fiber 30. Alternatively, the stress-applying portion 80 may also be disposed between the winding portion of the amplification optical fiber 30, and the connection point between the amplification optical fiber 30 and the optical fiber 32. The coefficient of thermal expansion of the inner cladding of the amplification optical fiber 30 according to the modification example is the same as the coefficient of thermal expansion of the cladding 53 according to the first embodiment, and the coefficient of thermal expansion of the coating layer of the amplification optical fiber 30 according to the modification example is the same as the coefficient of thermal expansion of the coating layer 55 according to the first embodiment. Further, the coefficient of thermal expansion of the outer cladding of the amplification optical fiber 30 according to the modification example is smaller than the coefficient of thermal expansion of the inner cladding of the amplification optical fiber 30 according to the modification example and that of the coating layer of the amplification optical fiber 30 according to the modification example. This contraction or expansion of the outer cladding has little effect on the contraction or expansion of the inner cladding, and little effect on the contraction or expansion of the stress-applying portion 80.

### Fifth Embodiment

Next, a fifth embodiment of the present invention will be described in detail with reference to FIG. 14. Note that, for constituent elements that are identical or equivalent to those of the fourth embodiment, the same reference signs are used and redundant descriptions are omitted, unless stated otherwise.

FIG. 14 is a diagram illustrating a laser device 1 according to this embodiment. The laser device 1 according to this embodiment comprises a light source 2, an optical fiber 50 that is connected to the light source 2, and an emitting portion 60 that is connected to the optical fiber 50.

The light source 2 comprises a pumping light source 40, a pumping optical fiber 45 connected to the pumping light source 40, and a resonator 200 connected to the pumping optical fiber 45 and the optical fiber 50. In the light source 2 according to this embodiment, the resonator 200 differs from the Fabry-Perot type resonator 200 according to the first embodiment in that the former is of the ring type.

The resonator 200 according to this embodiment comprises: an optical fiber 31; an amplification optical fiber 30; a beam quality control device 70 having the same configuration as the beam quality control device 70 according to the fourth embodiment; a combiner 121; an optical isolator 123; a bandpass filter 125; and an output coupler 127.

One end of the optical fiber 31 is connected to one end of the amplification optical fiber 30. The other end of the amplification optical fiber 30 is connected to one end of the optical fiber 32, and the other end of the optical fiber 32 is connected to the incident end of the optical isolator 123. The emitting end of the optical isolator 123 is connected to one end of an optical fiber 32 that is different from the foregoing optical fiber 32, and the other end of the optical fiber 32 is connected to the incident end of the bandpass filter 125. The emitting end of the bandpass filter 125 is connected to one end of yet another optical fiber 32 that is different from the foregoing optical fiber 32, and the other end of the optical fiber 32 is connected to the other end of the optical fiber 31 that is connected to the amplification optical fiber 30. Thus, a ring-shaped resonator is constituted as illustrated in FIG. 14, and the beam quality control device 70 is disposed inside the ring-shaped resonator 200. The stress-applying portion 80 of the beam quality control device 70 is disposed on the optical fiber 32, which is connected at one end to the optical fiber 31 and connected at the other end to the emitting end of the bandpass filter 125. In FIG. 14, the stress-applying portion 80 is omitted for easy viewing.

In the combiner 121, the core of the pumping optical fiber 45 is connected to the inner cladding of the optical fiber 31. Thus, the pumping optical fiber 45 and the inner cladding of the amplification optical fiber 30 are optically coupled via the inner cladding of the optical fiber 31. Furthermore, in the combiner 121, the core 32a of the optical fiber 32 in the beam quality control device 70 is connected to the core of the optical fiber 31. In FIG. 14, the core 32a is not illustrated.

The optical isolator 123 suppresses the return of light from the bandpass filter 125 side to the amplification optical fiber 30 side via the optical isolator 123.

The bandpass filter 125 restricts the bandwidth of the wavelengths of light that passes through the bandpass filter 125. The bandpass filter 125 restricts light of wavelengths different from the wavelength of the light emitted from the emitting portion 60, for example. The wavelength of the light emitted from the emitting portion 60 is, for example, 1070 nm.

In the output coupler 127, the core of the optical fiber 50 is optically connected to the core 32a of the optical fiber 32 that is connected to the output end of the bandpass filter 125. Therefore, a portion of the light from the bandpass filter 125 propagates through the core of the optical fiber 50, and another portion of the light propagates through the core 32a of the optical fiber 32 in the beam quality control device 70.

The operation of the laser device 1 will be described next.

The pumping light emitted from the pumping light source 40 enters the inner cladding of the amplification optical fiber 30 via the core of the pumping optical fiber 45 and the inner cladding of the optical fiber 31. The pumping light incident on the inner cladding of the amplification optical fiber 30 mainly propagates through this inner cladding and pumps the active element added to the core when passing through the core of the amplification optical fiber 30. The active element, which is in a pumped state, emits spontaneous emission light, and light of some wavelengths of this spontaneous emission light enters the core 32a of the optical fiber 32 and is propagated to the output coupler 127 via the optical isolator 123 and the bandpass filter 125. In the optical isolator 123, the return of light from the bandpass filter 125 side to the amplification optical fiber 30 side via the optical isolator 123 is suppressed. Further, in the bandpass filter 125, the bandwidth of wavelengths of the light passing through the bandpass filter 125 is limited. A portion of the bandwidth-limited light propagates from the output coupler 127 to the beam quality control device 70. Light is then propagated from the core 32a of the optical fiber 32 in the beam quality control device 70 to the core of the optical fiber 31 and travels around inside the resonator 200. As the light travels around the inside of the resonator 200, the active element in the amplification optical fiber 30 undergoes induced emission due to the light that has been bandwidth-limited by the bandpass filter 125. Due to the induced emission, the light is amplified in a predetermined wavelength band, and the amplified light propagates through the optical fiber 32.

In the beam quality control device 70, the stress-applying portion 80 changes the state of the optical fiber 32. Accordingly, the distribution of the refractive index of the core 32a of the optical fiber 32 is varied according to the intended use of the laser device 1, such as cutting or shaving off. Each time the light traveling around the inside of the resonator 200 propagates through the core 32a of the optical fiber 32 of the beam quality control device 70, the number of modes of light in the core 32a changes according to the intended use. Thus, for example, according to the intended use, single-mode light changes to multi-mode light, the number of modes of multi-mode light decreases, and multi-mode light changes to single-mode light. The beam quality of the light varies greatly in comparison with a case where the beam quality control device 70 is disposed outside the resonator 200, and hence light of the desired beam quality that corresponds to the intended use is obtained. With the desired beam quality corresponding to the intended use, a portion of the light is then made to enter the core of the optical fiber 50 from the output coupler 127, propagates through the core of the optical fiber 50, and is irradiated from the emitting portion 60 onto an object or the like. Further, another portion of the light travels around the inside of the resonator 200.

As mentioned above, in the laser device 1, light travels around the inside of the resonator 200, and the stress-applying portion 80 changes the state of the optical fiber 32. Therefore, as the light propagates through the core 32a of the optical fiber 32 each time same travels around the inside of the resonator 200, the mode of the light can change in the core 32a, and light of the desired beam quality can be obtained. Therefore, in the laser device 1 according to this embodiment, because the light propagates through the core 32a every time the light travels around the inside of the resonator 200, the beam quality can vary more greatly than when the beam quality control device is disposed outside the resonator 200, and light of the desired beam quality corresponding to the intended use can be obtained.

Also, with the laser device 1 according to this embodiment, light of the desired beam quality can be obtained in a short time in the same way as light of the desired beam quality is obtained in a short time according to the fourth embodiment. Further, similarly to the laser device 1 according to the fourth embodiment, an increased size and higher cost, or the like, for the laser device 1 according to this embodiment are suppressed.

In addition, because the amplification optical fiber 30 of the beam quality control device 70 is disposed so as to be wound, the laser device 1 can be made smaller than when an amplification optical fiber with the same length as the wound amplification optical fiber 30 is arranged linearly.

### Sixth Embodiment

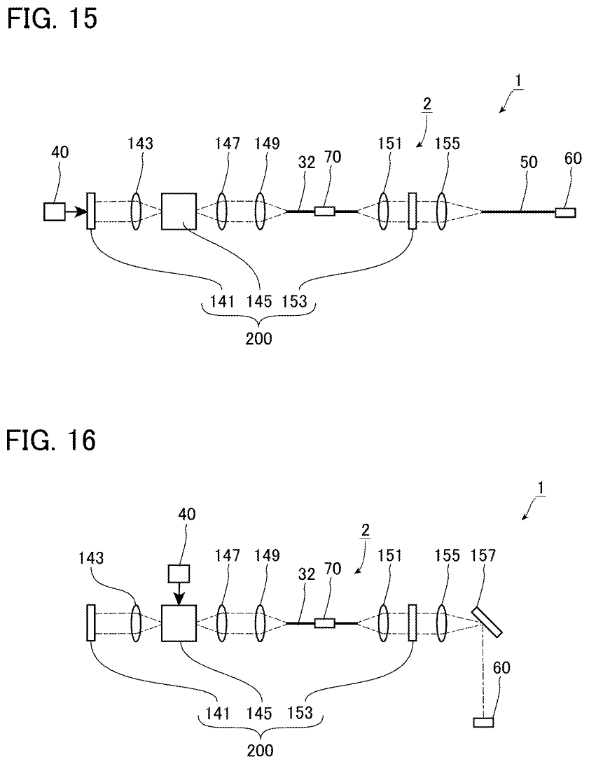

Next, a sixth embodiment of the present invention will be described in detail with reference to FIG. 15. Note that, for constituent elements that are identical or equivalent to those of the fourth embodiment, the same reference signs are used and redundant descriptions are omitted, unless stated otherwise.

FIG. 15 is a diagram illustrating a laser device 1 according to this embodiment. The laser device 1 according to this embodiment comprises a light source 2, an optical fiber 50, and an emitting portion 60.

The light source 2 according to this embodiment differs from the light source 2 consisting of a fiber laser device according to the fourth embodiment in that same consists of a solid-state laser device.

The light source 2 comprises, in a main configuration, with: a pumping light source 40, a total reflection mirror 141, a focusing lens 143, an amplification medium 145, a collimating lens 147, a focusing lens 149, a beam quality control device 70, a collimating lens 151, a partial reflection mirror 153, and a focusing lens 155.

The pumping light emitted from the pumping light source 40 is transmitted by the total reflection mirror 141. Further, the total reflection mirror totally reflects the light in a predetermined wavelength band in the spontaneous emission light emitted by the active element in the amplification medium 145 that has been pumped by the pumping light.

The focusing lens 143 focuses the pumping light transmitted through the total reflection mirror 141 onto the amplification medium 145.

For example, the amplification medium 145 is a glass rod, and the material of the glass rod is Nd:YAG. The pumping light from the pumping light source 40 pumps the active element that is added to the amplification medium 145. The active element, which is in a pumped state, emits spontaneous emission light, and a portion of the light of some wavelengths of this spontaneous emission light propagates to the collimating lens 147, and another portion of the light propagates to the total reflection mirror 141 via the focusing lens 143.

The collimating lens 147 converts the light emitted from the amplification medium 145 into collimated light.

The focusing lens 149 focuses the light converted to collimated light by the collimating lens 147 onto the core 32a of the optical fiber 32 of the beam quality control device 70.

The beam quality control device 70 according to this embodiment has the same configuration as the beam quality control device 70 according to the fourth embodiment.

The collimating lens 151 converts the light emitted from the beam quality control device 70 into collimated light.

The partial reflection mirror 153 reflects a portion of the light converted to collimated light by the collimating lens 151 back to the collimating lens 151. Further, the partial reflection mirror 153 reflects light of at least some wavelengths of the light reflected by the total reflection mirror 141 at a lower reflectance than the total reflection mirror 141. Another portion of the light is transmitted through the partial reflection mirror 153.

The focusing lens 155 focuses the light transmitted through the partial reflection mirror 153 onto the optical fiber 50.

In the light source 2 according to this embodiment, the Fabry-Perot type resonator 200 is constituted by the total reflection mirror 141, the amplification medium 145, and the partial reflection mirror 153, and the beam quality control device 70 is disposed inside the Fabry-Perot type resonator 200.

Next, the operation of the laser device 1 according to this embodiment will be described.

The pumping light emitted from the pumping light source 40 passes through the total reflection mirror 141 and is focused on the amplification medium 145 by the focusing lens 143. The pumping light pumps the active element that is added to the amplification medium 145. The active element, which is in a pumped state, emits spontaneous emission light, and light of some wavelengths of this spontaneous emission light is reflected by the amplification medium 145. A portion of the light propagates to the collimating lens 147 and another portion of the light propagates to the focusing lens 143.

The light propagating to the collimating lens 147 is converted to collimated light by the collimating lens 147. The collimated light is focused by the focusing lens 149 on the core 32a of the optical fiber 32 of the beam quality control device 70. The light is emitted from the core 32a toward the collimating lens 151 and converted to collimated light by the collimating lens 151. Light of some wavelengths of the collimated light is reflected to the collimating lens 151 by the partial reflection mirror 153.

The reflected light is focused by the collimating lens 151 onto the core 32a of the optical fiber 32 of the beam quality control device 70. The light is emitted from the core 32a toward the focusing lens 149, converted to collimated light by the focusing lens 149, and focused onto the amplification medium 145 by the collimating lens 147. The light passes through the amplification medium 145 and propagates to the focusing lens 143.

The light propagating from the amplification medium 145 to the focusing lens 143 is converted to collimated light by the focusing lens 143 and propagates to the total reflection mirror 141. Light of some wavelengths of the propagating light is totally reflected by the total reflection mirror 141 and, as described above, propagates back toward the partial reflection mirror 153. The light then travels back and forth between the total reflection mirror 141 and the partial reflection mirror 153, that is, inside the resonator 200. Therefore, light is amplified through induced emission in the amplification medium 145, and a laser oscillation state is generated. A portion of the light then passes through the partial reflection mirror 153 and is made to enter the core of the optical fiber 50 by the focusing lens 155. The light propagates through the core of the optical fiber 50 and is irradiated from the emitting portion 60 onto an object or the like.

The beam quality control device 70 is disposed between the total reflection mirror 141 and the partial reflection mirror 153, and the distribution of the refractive index of the core 32a of the optical fiber 32 is changed by the beam quality control device 70 according to the intended use of the laser device 1, such as cutting or shaving off. Hence, each time the light travels back and forth inside the resonator 200 propagates through the core 32a, the number of modes of light in the core 32a changes according to the intended use. Thus, for example, according to the intended use, single-mode light changes to multi-mode light, the number of modes of multi-mode light decreases, and multi-mode light changes to single-mode light. The beam quality of the light varies greatly in comparison with a case where the beam quality control device 70 is disposed outside the resonator 200, and hence light of the desired beam quality that corresponds to the intended use is obtained.

Therefore, in the laser device 1 according to this embodiment, even if the light source 2 consists of a solid-state laser device, the beam quality can vary more greatly and light of the desired beam quality can be obtained, in comparison with a case where the beam quality control device 70 is disposed outside the resonator 200, because the light travels back and forth inside the resonator 200. Also, with the laser device 1 according to this embodiment, light of the desired beam quality can be obtained in a short time in the same way as light of the desired beam quality is obtained in a short time according to the fourth embodiment. Further, similarly to the laser device 1 according to the fourth embodiment, an increased size and higher cost, or the like, for the laser device 1 according to this embodiment are suppressed.

### Seventh Embodiment

Next, a seventh embodiment of the present invention will be described in detail with reference to FIG. 16. Note that, for constituent elements that are identical or equivalent to those of the sixth embodiment, the same reference signs are used and redundant descriptions are omitted, unless stated otherwise.

FIG. 16 is a diagram illustrating a laser device 1 according to this embodiment. The laser device 1 according to this embodiment comprises a light source 2, a reflecting mirror 157, and an emitting portion 60.

The light source 2 according to this embodiment differs from the light source 2 consisting of a solid-state laser device according to the sixth embodiment in that same consists of a gas laser device.

The light source 2 differs from that of the sixth embodiment in that the pumping light source 40 emits pumping light to the amplification medium 145 and in the configuration of the amplification medium 145.

The amplification medium 145 according to this embodiment is a glass tube in which a gas, such as CO₂, for example, is sealed. In the amplification medium 145, when the pumping light irradiates the gas, the gas, which is in a pumped state, emits spontaneous emission light, and light of some wavelengths of the spontaneous emission light is emitted. The light travels back and forth between the total reflection mirror 141 and the partial reflection mirror 153, that is, inside the resonator 200. Therefore, light is amplified through induced emission in the amplification medium 145, and a laser oscillation state is generated. A portion of the light then passes through the partial reflection mirror 153 and is made to enter the reflecting mirror 157 by the focusing lens 155. The light is reflected by the reflecting mirror 157 to the emitting portion 60 and irradiated from the emitting portion 60 onto an object or the like.

The beam quality control device 70 according to this embodiment is disposed between the total reflection mirror 141 and the partial reflection mirror 153, and the distribution of the refractive index of the core 32a of the optical fiber 32 is changed by the beam quality control device 70 according to the intended use of the laser device 1, such as cutting or shaving off. Hence, each time the light travels back and forth inside the resonator 200 propagates through the core 32a, the number of modes of light in the core 32a changes according to the intended use. Thus, for example, according to the intended use, single-mode light changes to multi-mode light, the number of modes of multi-mode light decreases, and multi-mode light changes to single-mode light. The beam quality of the light varies greatly in comparison with a case where the beam quality control device 70 is disposed outside the resonator 200, and hence light of the desired beam quality that corresponds to the intended use is obtained.

Therefore, in the laser device 1 according to this embodiment, even if the light source 2 consists of a gas laser device, the beam quality can vary more greatly and light of the desired beam quality can be obtained, in comparison with a case where the beam quality control device 70 is disposed outside the resonator 200, because the light travels back and forth inside the resonator 200. Also, with the laser device 1 according to this embodiment, light of the desired beam quality can be obtained in a short time in the same way as light of the desired beam quality is obtained in a short time according to the fourth embodiment. Further, similarly to the laser device 1 according to the fourth embodiment, an increased size and higher cost, or the like, for the laser device 1 according to this embodiment are suppressed.

Although the present invention has been described above using the foregoing embodiments as examples, the present invention is not limited to or by these embodiments and can be suitably changed.

The stress-applying portion 80 should be in surface contact with at least a portion of the outer peripheral surface of the coating layers 32c, 55.

Further, in the beam quality control device 70 according to the first embodiment, the coating layer 55 is not disposed on the cladding 53, and the optical fiber 50 may have only the core 51 and the cladding 53. In this case, the stress-applying portion 80 should be in surface contact with at least a portion of the outer peripheral surface of the cladding 53. In addition, even when the coating layer 55 is not in place, the stress-applying portion 80 can contract or expand. Accordingly, even when the coating layer 55 is not in place, the external force applied to the cladding 53 by the stress-applying portion 80 changes non-uniformly in the peripheral direction of the cladding 53. If the external force changes non-uniformly, the distribution of stress applied to the core 51 becomes non-uniform in the peripheral direction of the core 51, the distribution of the refractive index of the core 51 changes, and the mode of light propagating through the core 51 may change. In addition, in the beam quality control device 70, because the beam quality is controlled in the optical fiber 50, unintended changes in the beam quality can be suppressed in comparison with a case where the beam quality is controlled by arranging a lens in space, even when vibrations or changes in environmental temperature, or the like, occur. Therefore, this beam quality control device 70 provides light of the desired beam quality. Although described here using the beam quality control device 70 according to the first embodiment, in the beam quality control device 70 according to the fourth embodiment, the optical fiber 32 has the same configuration as the optical fiber 50, and the stress-applying portion 80 surrounding the optical fiber 32 has the same configuration as the stress-applying portion 80 according to the first embodiment surrounding the optical fiber 50, as described above. Thus, the optical fiber 32 may have only the core 32a and the cladding 32b. In this case, the stress-applying portion 80 should be in surface contact with at least a portion of the outer peripheral surface of the cladding 32b. In this case also, this beam quality control device 70 provides light of the desired beam quality.

For example, the stress-applying portion 80 may surround the outer peripheral surface of the optical fibers 32, 50 over the entire length of the optical fibers 32, 50. Alternatively, the stress-applying portion 80 may be in surface contact with the outer peripheral surface of at least a portion of the optical fibers 32, 50 in the longitudinal direction, surrounding the outer peripheral surface of this portion over the entire circumference thereof and gaplessly adhering to the outer peripheral surface of the portion. Note that the stress-applying portion 80 may also be disposed on at least a portion of the outer peripheral surface of the portion. In a case where the stress-applying portion 80 surrounds the optical fibers 32, 50 in a section of the total length of the optical fibers 32, 50, a plurality of stress-applying portions 80 may also be arranged spaced apart from each other.

The temperature control main body portion 91 may directly input, from the input portion 113, the value of a temperature of the stress-applying portion 80 which corresponds to the intended use of the laser device 1.

The temperature-controlling portion 90 may also have a temperature measurement unit that measures the temperature of the stress-applying portion 80. In this case, the temperature control main body portion 91 may further control the voltage of the power supply 93 on the basis of the temperature of the stress-applying portion 80 as measured by the temperature measurement unit. The temperature measured by the temperature measurement unit is fed back to the temperature control main body portion 91, and the feedback is repeated, whereby the temperature of the stress-applying portion 80 is controlled such that the temperature of the stress-applying portion 80 is set to a target temperature which corresponds to the intended use of the laser device 1. Examples of the control method of the stress-applying portion 80 include ON-OFF control, PWM control, and PID control, and the like.

The temperature-controlling portion 90 may change the temperature of the stress-applying portion 80 without generating or absorbing heat itself. This temperature-controlling portion 90 may, for example, change the temperature of the stress-applying portion 80 by irradiating same with infrared rays and ultrasonic waves, or the like.

The heat-conducting member 111 does not need to be limited to a plate shape as long as same can conduct heat.

In the beam quality control device 70, the coefficient of thermal expansion of the stress-applying portion 80 may be smaller than the coefficient of thermal expansion of the cladding 32b, 53. In this case, the stress-applying portion 80 contracts less than the cladding 32b, 53. The stress-applying portion 80 can then apply a small tensile stress to the cladding 32b, 53 by slightly pulling the cladding 32b, 53 via the coating layers 32c, 55 at the inner peripheral surface of the stress-applying portion 80 in comparison with a case where the coefficient of thermal expansion of the stress-applying portion 80 is larger than the coefficient of thermal expansion of the cladding 32b, 53. In this case, the stress-applying portion 80 also expands less than the cladding 32b, 53. The stress-applying portion 80 can then apply a small compressive stress to the cladding 32b, 53 by slightly pressing the cladding 32b, 53 via the coating layer 55 at the inner peripheral surface of the stress-applying portion 80 in comparison with a case where the coefficient of thermal expansion of the stress-applying portion 80 is larger than the coefficient of thermal expansion of the cladding 32b, 53.

In the beam quality control devices 70 according to the first, and third to seventh embodiments, a heater may also be used instead of the Peltier element 95.

The beam quality control devices 70 according to the first, second, and third embodiments may be disposed outside the resonator 200, and may be disposed in the delivery optical fiber 10, for example.

The number of light sources 2 is not particularly limited in the laser devices according to the first to seventh embodiments, and at least one thereof should be provided. Moreover, the beam quality control devices 70 according to the fourth to seventh embodiments may be disposed inside the resonator 200 of any of the plurality of light sources 2.

The beam quality control devices 70 according to the second and third embodiments may be disposed between the emitting portion 60 and the area of the second FBG which is farthest from the connection point between the amplification optical fiber 30 and the optical fiber 32.

The frame member 117 according to the second embodiment may be incorporated into the beam quality control devices 70 according to the first, and fourth to seventh embodiments.

The Peltier element 95 according to the first, and third to seventh embodiments is not in place, the flow passage 99 according to the second embodiment is incorporated into the heat-conducting member 111 according to the first, and third to seventh embodiments, and the heat pump 97 may be incorporated in place of the power supply 93 according to the first, and third to seventh embodiments.

In the beam quality control device 70 according to the third embodiment, the heat-conducting member 111 which has the flow passage 99 according to the second embodiment may be in place, or the flow passage 99 may be arranged on the plate member 81, in place of the Peltier element 95 according to the first embodiment.

In the beam quality control device 70 according to the third embodiment, the wall members 83 may also be fixed to the optical fiber 50. In this case, when the temperature of one side of the Peltier element 95 rises and the temperature of the other side falls, the plate member 81 expands and the pair of wall members 83 move away from each other. Accordingly, the pair of wall members 83 can then pull the cladding 53 fixed to the wall members 83 from both sides and can apply a tensile stress to the cladding 53.

Furthermore, in the laser device 1 according to the foregoing embodiment, the light source 2 was described using the example of a resonator-type fiber laser device, but the light source 2 may be another fiber laser device. If the light source 2 is to be another fiber laser device, the light source 2 may be a MO-PA (Master Oscillator Power Amplifier)-type fiber laser device with a seed light source, or may be a DDL (Direct Diode Laser)-type laser device. If the light source 2 is a MO-PA type fiber laser device, the beam quality control device 70 should be disposed between the seed light source and the emitting portion. However, when the beam quality control device 70 is disposed between the amplification optical fiber that amplifies the light emitted from the seed light source, and the emitting portion, the beam quality control device 70 may make it easier to bring light with a high power density closer to the desired beam quality than when the beam quality control device 70 is disposed between the seed light source and the amplification optical fiber, and may make it easier to bring the beam quality of the light emitted from the emitting portion 60 closer to the desired beam quality. In the case of a DDL-type laser device, the light source 2 illustrated in FIG. 1 may be a laser diode, and a beam quality control device 70 may be disposed between the light source 2 and the emitting portion 60.

The amplification optical fiber 30 or the optical fiber 31 is described as a double-clad fiber having an inner cladding and an outer cladding, but is not limited thereto. For example, the inner cladding is divided into two layers, and the amplification optical fiber 30 and optical fiber 31 may be a triple-clad fiber with three layers of cladding, namely two layers of inner cladding and an outer cladding. In this case, in the two layers of inner cladding, the refractive index of an inner first cladding may be lower than the refractive index of an outer second cladding, for example. The refractive index of the second cladding may also be lower than the refractive index of the outer cladding.

The optical fiber in the beam quality control device 70 according to the fifth embodiment may be the amplification optical fiber 30.

The configuration of the beam quality control device 70 disposed inside the resonator 20 may also be the same as the configuration of the beam quality control device 70 according to the second embodiment or the same as the configuration of the beam quality control device 70 according to the third embodiment. In the laser device according to the fifth, sixth, and seventh embodiments, the beam quality control device 70 according to the fourth embodiment does not need to be used, and any of the beam quality control devices 70 according to the second and third embodiments may be used. In the laser device 1, the beam quality control device 70 may be disposed both inside the resonator 20 and outside the resonator 20.

The storage portion 115 may also store the relationship between the information on the beam quality of the light emitted from the laser device 1 and the temperature of the stress-applying portion 80. The information is, for example, an indication of how small the beam waist diameter can be, and is expressed in terms of Beam Parameter Products (BPP). BPP[mm·rad] is expressed as r₀×θ, or M²(M squared)×λ/π. r₀ is the beam waist radius, and θ is the full width at half maximum of the beam divergence angle. Also, λ is the wavelength of light (μm). When the beam quality is good, the value of BPP is small. The temperature-controlling portion 90 reads the temperature in the relevant relationship stored in the storage portion 115, and controls the temperature of the stress-applying portion 80 to the read temperature. Therefore, the temperature-controlling portion 90 controls the temperature of the stress-applying portion 80 to the temperature based on the information stored in the storage portion 115.

Due to the foregoing configuration, in the laser device 1, the temperature-controlling portion 90 controls the temperature of the stress-applying portion 80 on the basis of the information stored in the storage portion 115, and when the temperature of the stress-applying portion 80 becomes the temperature based on this information, the beam quality of the light emitted from the laser device 1 can be the beam quality stored in the storage portion 115. As a result, light of the beam quality stored in the storage portion 115 is emitted, and the light can irradiate the object.

Embodiments of the present invention provide a beam quality control device capable of obtaining light of a desired beam quality and a laser device using the same, which can be used in various industries such as the laser processing field and the medical field.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1. A beam quality control device, comprising:
an optical fiber having a core and a cladding that surrounds an outer peripheral surface of the core;
a stress-applying portion that is in surface contact with at least a portion of an outer peripheral surface of the optical fiber and that has a coefficient of thermal expansion of the stress-applying portion that is different from a coefficient of thermal expansion of the cladding; and
a temperature controller that controls a temperature of the stress-applying portion,
wherein the stress-applying portion contracts or expands due to the temperature being changed by the temperature controller such that a distribution of an external force applied by the stress-applying portion to the cladding becomes non-uniform in a peripheral direction of the cladding.

2. The beam quality control device according to claim 1, further comprising:
a heat-conducting plate, is thermally connected to the stress-applying portion and the temperature controller, and conducts heat between the temperature controller and the stress-applying portion, wherein
the stress-applying portion is disposed on a main surface of the heat-conducting plate.

3. The beam quality control device according to claim 2, wherein the temperature controller includes:
a heat pump; and
a flow passage, that penetrates the heat-conducting plate, wherein
a fluid flows through the flow passage,
the heat pump changes the temperature of the fluid, and
the flow passage changes the temperature of the stress-applying portion using the fluid.

4. The beam quality control device according to claim 1,
wherein the stress-applying portion is made of a resin with a non-uniform thickness between a contact surface that is in surface contact with the outer peripheral surface of the optical fiber and the outer peripheral surface of the stress-applying portion, and
the outer peripheral surface of the stress-applying portion is spaced apart from the contact surface.

5. The beam quality control device according to claim 4,
wherein, when the temperature of the resin is lower than a predetermined temperature, the resin contracts and applies a tensile stress to the cladding, and
wherein, when the temperature of the resin is higher than the predetermined temperature, the resin expands and applies a compressive stress to the cladding.

6. The beam quality control device according to claim 1, further comprising:
a frame member that surrounds at least a portion of the stress-applying portion,
wherein a coefficient of thermal expansion of the frame member is smaller than the coefficient of thermal expansion of the stress-applying portion.

7. The beam quality control device according to claim 1, wherein
the stress-applying portion includes:
a plate member; and
a pair of wall members that stand upright on the plate member and sandwich the optical fiber,
the plate member contracts or expands in a direction of alignment of the pair of wall members, and
the pair of wall members applies a compressive stress to the cladding through contraction of the plate member, and the pair of wall members releases the compressive stress through expansion of the plate member.

8. A laser device, comprising:
the beam quality control device according to claim 1; and
a light source that emits light,
wherein the light propagates through the core.

9. A laser device, comprising:
the beam quality control device according to claim 1; and
a pumping light source that emits pumping light,
wherein the optical fiber propagates light amplified by an active element that is pumped by the pumping light.

10. The laser device according to claim 9, further comprising:
an amplification optical fiber to which the active element is added;
a first fiber Bragg grating (FBG) that is disposed on one side of the amplification optical fiber and that reflects light of at least some wavelengths of the light amplified by the active element;
a second FBG that is disposed on an opposite side of the amplification optical fiber and that reflects light of at least some wavelengths of the light reflected by the first FBG, at a lower reflectance than the first FBG; and
an emitting portion that emits light transmitted through the second FBG toward an object,
wherein the beam quality control device is disposed between the emitting portion and an area of the second FBG which is farthest from a connection point between the amplification optical fiber and the optical fiber where the second FBG is disposed.

11. The laser device according to claim 9, further comprising:
a resonator that causes the light amplified by the active element pumped by the pumping light, to resonate,
wherein the beam quality control device is disposed inside the resonator.

12. The laser device according to claim 11,
wherein the resonator comprises:
an amplification optical fiber to which the active element is added;
a first fiber Bragg grating (FBG) that is disposed on one side of the amplification optical fiber and that reflects light of at least some wavelengths of the light amplified by the active element; and
a second FBG that is disposed on an opposite side of the amplification optical fiber and that reflects light of at least some wavelengths of the light reflected by the first FBG at a lower reflectance than the first FBG, and
wherein the beam quality control device is disposed between a connection point between the amplification optical fiber and the optical fiber where the first FBG is disposed, and an area of the first FBG which is farthest from the connection point.

13. The laser device according to claim 11,
wherein the resonator comprises:
an amplification optical fiber to which the active element is added;
a first fiber Bragg grating (FBG) that is disposed on one side of the amplification optical fiber and that reflects light of at least some wavelengths of the light amplified by the active element; and
a second FBG that is disposed on an opposite side of the amplification optical fiber and that reflects light of at least some wavelengths of the light reflected by the first FBG at a lower reflectance than the first FBG, and
wherein the amplification optical fiber is the optical fiber in the beam quality control device.

14. The laser device according to claim 11,
wherein the resonator comprises:
an amplification optical fiber to which the active element is added;
a first fiber Bragg grating (FBG) that is disposed on one side of the amplification optical fiber and that reflects light of at least some wavelengths of the light amplified by the active element; and
a second FBG that is provided disposed on the other an opposite side of the amplification optical fiber and that reflects light of at least some wavelengths of the light reflected by the first FBG at a lower reflectance than the first FBG, and wherein the beam quality control device is disposed between a connection point between the amplification optical fiber and the optical fiber where the second FBG is disposed, and an area of the second FBG which is farthest from the connection point.

15. The laser device according to claim 8, further comprising:
a memory that stores information on the beam quality of light emitted from the laser device,
wherein temperature controller controls the temperature of the stress-applying portion to a temperature based on the information stored in the memory.
